(19) United States
(12) Patent Application Publication
(10) Pub. No.: US 2025/0229366 A1
(43) Pub. Date: Jul. 17, 2025

(54) SYSTEMS AND METHODS FOR CONTROLLING WELD TOOL BASED ON DETECTED CHARACTERISTICS OF WORK SETTING AND/OR USER

(71) Applicant: BlueForge Alliance, Bryan, TX (US)

(72) Inventor: Arnold KRAVITZ, St. Petersburg, FL (US)

(21) Appl. No.: 19/170,544

(22) Filed: Apr. 4, 2025

Related U.S. Application Data
(63) Continuation-in-part of application No. 18/394,298, filed on Dec. 22, 2023.
(60) Provisional application No. 63/640,457, filed on Apr. 30, 2024.
(60) Provisional application No. 63/607,354, filed on Dec. 7, 2023.

(51) Int. Cl. B23K 31/12; B23K 37/02; G01H 3/06; G05B 19/418

(52) U.S. Cl. CPC B23K 31/125; G01H 3/06; G05B 19/41875; B23K 37/0229; G05B 2219/32222; G05B 2219/45104

(57) ABSTRACT

A system includes a microphone configured to generate audio signals associated with a weld tool being used by a user to perform a welding operation on an object. A processing device executes an artificial intelligence agent trained to perform several functions to determine certain information. These functions include processing the audio signals to identify sound signatures indicative of a weld defect occurring during the welding operation, determining the presence of the weld defect based on the identified sound signatures, and issuing cease commands to cease operation of the weld tool in response to the determined presence of the weld defect. The system may also include a welding robot, peripheral haptic devices, and network interfaces to support remote interaction and haptic feedback between users. The system aims to enhance welding quality control through real-time audio monitoring and immediate intervention capabilities.

### CROSS-REFERENCES TO RELATED APPLICATIONS

This application claims priority to, and the benefit of, U.S. Patent Application Ser. No. 63/640,457 filed Apr. 30, 2024, titled “SYSTEMS AND METHODS FOR CONTROLLING WELD TOOL BASED ON DETECTEDCHARACTERISTICS OF WORK SETTING AND/OR USER,” the entire disclosure of which is hereby incorporated by reference for all purposes.

This application a continuation-in-part of and claims priority to, and the benefit of, U.S. patent application Ser. No. 18/394,298 filed Dec. 22, 2023, titled “SYSTEMS AND METHODS FOR USING A VOCATIONAL MASK WITH A HYPER-ENABLED WORKER,” which claims priority to U.S. Application Patent Ser. No. 63/607,354 filed Dec. 7, 2023, titled “SYSTEMS AND METHODS FOR USING A VOCATIONAL MASK WITH A HYPER-ENABLED WORKER,” the entire disclosure of which is hereby incorporated by reference for all purposes.

### TECHNICAL FIELD

This disclosure relates to methods and systems for utilizing machine learning and artificial intelligence to automatically control a work session based on detected characteristics of the work setting and/or the worker. In embodiments, the methods and systems include automatically controlling a work tool (e.g., welding tool) and/or automatically initiating a telework session based on the detected characteristics of the work setting and/or the worker.

### BACKGROUND

People use various tools and/or equipment to perform various vocations. For example, a welder may use a welding mask and/or a welding gun to weld an object. The welder may participate in training courses prior to welding the object. A master welder may lead the training courses to train the welder how to properly weld. In some instances, the master welder may be located at a physical location that is remote from where a student welder is physically located.

### SUMMARY

In one embodiment, a system includes a microphone configured to generate audio signals associated with a weld tool being used by a user to perform a welding operation on an object, a memory device storing instructions, and a processing device communicatively coupled to the memory device and the microphone. The processing device executes the instructions to execute an artificial intelligence agent trained to perform at least one or more functions to determine certain information. The one or more functions comprise processing the audio signals to identify sound signatures in the audio signals that are indicative of a weld defect occurring during the welding operation, determining a presence of the weld defect based on the identified sound signatures, and issuing cease commands to cease operation of the weld tool in response to the determined presence of the weld defect.

In one embodiment, a computer-implemented method comprises steps to generate audio signals associated with a weld tool being used by a user during a welding operation on an object; execute an artificial intelligence agent trained to perform functions to determine information; process the audio signals to identify sound signatures indicative of a weld defect; determine the presence of the weld defect based on these signatures; and issue commands to cease operation of the weld tool in response to the detected defect.

In embodiments, non-transitory computer-readable media can store instructions that, when executed, perform the methods described herein.

Other technical features may be readily apparent to one skilled in the art from the following figures, descriptions, and claims.

### BRIEF DESCRIPTION OF THE DRAWINGS

For a detailed description of example embodiments, reference will now be made to the accompanying drawings in which:

FIG. 1 illustrates a system architecture according to certain embodiments of this disclosure.

FIG. 2 illustrates a component diagram for a vocational mask according to certain embodiments of this disclosure.

FIG. 3 illustrates bidirectional communication between communicatively coupled vocational masks according to certain embodiments of this disclosure.

FIG. 4 illustrates an example of projecting an image onto a user's retina via a virtual retinal display of a vocational mask according to certain embodiments of this disclosure.

FIG. 5 illustrates an example of an image including instructions projected via a virtual retinal display of a vocational mask according to certain embodiments of this disclosure.

FIG. 6 illustrates an example of an image including a warning projected via a virtual retinal display of a vocational mask according to certain embodiments of this disclosure.

FIG. 7 illustrates an example of a method for executing an artificial intelligence agent to determine certain information projected via a vocational mask of a user according to certain embodiments of this disclosure.

FIG. 8 illustrates an example of a method for transmitting instructions for performing a task via bidirectional communication between a vocational mask and a computing device according to certain embodiments of this disclosure.

FIG. 9 illustrates an example of a method for implementing instructions for performing a task using a peripheral haptic device according to certain embodiments of this disclosure.

FIG. 10 illustrates an example computer system according to embodiments of this disclosure.

FIG. 11 illustrates a system for performing robotic work, for example a robotic welding operation according to an embodiment.

FIG. 12 illustrates an example of a computer-implemented method according to certain embodiments of this disclosure; and

FIG. 13 illustrates another example of a computer-implemented method according to certain embodiments of this disclosure.

### NOTATION AND NOMENCLATURE

Various terms are used to refer to system components. Different entities may refer to a component by different names-this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or a direct connection, unless specified. For example, if a first device couples to a second device, that connection may be through a direct connection or through an indirect connection via other devices and connections.

The terminology used herein is for the purpose of describing example embodiments only and is not intended to be limiting. As used herein, the singular forms “a,” “an,” and “” they “” may be intended to refer to both singular and plural referents unless the context clearly dictates otherwise. By way of example, “a processor” programmed to perform various functions refers to one processor programmed to perform each function, or more than one processor collectively programmed to perform each of the various functions. The method steps, processes, and operations described herein are not to be construed as necessarily requiring their performance in the order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

The following discussion is directed to various embodiments of the disclosed subject matter. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

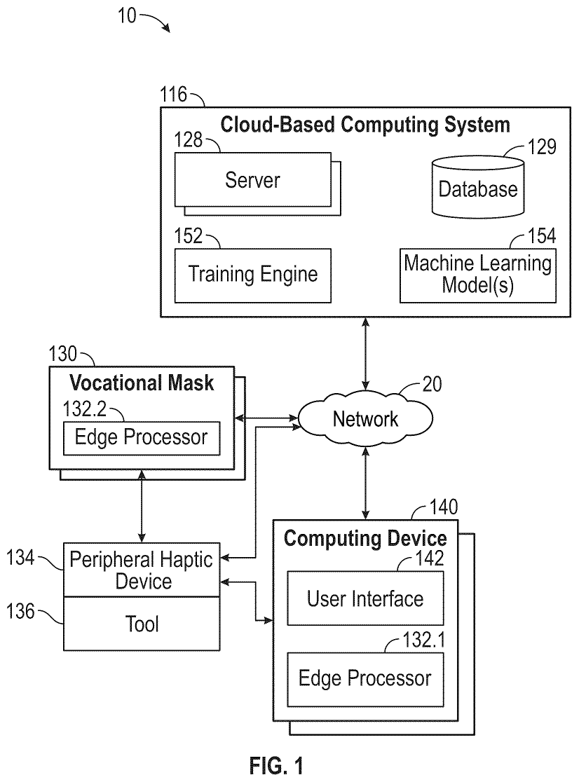

FIGS. 1 through 12 discussed below, and the various embodiments used to describe the principles of this disclosure in this patent document are by way of illustration only and should not be construed in any way to limit the scope of the disclosure.

Some of the disclosed embodiments relate to one or more artificial intelligent enhanced vocational tools for workers to use to perform a job, task, and/or vocation. In some embodiments, the vocational tools may be in the form of a vocational mask that projects work instructions using imagery, animation, video, text, audio, and the like. The vocational tools may be used by workers to enhance the efficiency and proficiency of performing professional and vocational tasks, such as but not limited to supply chain operations, manufacturing and warehousing processes, product inspection, coworker and master-apprentice bidirectional collaboration and communication with or without haptic sensory feedback, other telepresence, and the like.

Some of the disclosed embodiments may be used to collect data, metadata, and multiband video to aid in product acceptance, qualification, and full lifecycle product management. Further, some of the disclosed embodiments may aid a failure reporting, analysis, and corrective action system, a failure mode, effects, and criticality analysis system, other sustainment and support activities and tasks to accommodate worker dislocation and multi-decade lifecycle of some products.

The disclosed job, task, and/or vocation may include or relate to robotic work sessions. In examples, a robotic unit may be configured to perform a task, such as welding. A human worker can control the robotic unit directly, remotely, and the like. At least some of the tasks performed by the robotic unit can be autonomous or automatic, with the human worker overseeing or controlling some of the functions or tasks performed by the robotic unit.

In one embodiment, a vocational mask is disclosed that employs bidirectional communication to include voice and imagery and still and audio video imagery recording with other colleagues over a distance. The vocational mask may provide virtual images of objects to a person wearing the vocational mask via a display (e.g., virtual retinal display). The vocational mask may enable bidirectional communications with collaborators and/or students. Further, the vocational mask may enable bidirectional audio, visual, and haptic communication to provide a master-apprentice relationship. The vocational mask may include multiple electromagnetic spectrum and acoustic sensors/imagers. The vocational mask may also provide multiband audio and video sensed imagery to a wearer of the vocational mask.

The vocational mask may be configured to provide display capabilities to project images onto one or more irises of the wearer to display alphanumeric data and graphic/animated work instructions, for example. The vocational mask may also include one or more speakers to emit audio related to work instructions, such as those provided by a master trained user, supervisor, collaborator, teacher, etc.

The vocational mask may include an edge-based processor that executes an artificial intelligence agent. The artificial intelligence agent may be implemented in computer instructions stored on one or more memory devices and executed by one or more processing devices. The artificial intelligence agent may be trained to perform one or more functions, such as but not limited to (i) perception-based object and feature identification, (ii) cognition-based scenery understanding, to identify material and assembly defects versus acceptable features, and (iii) decision making to aid the wearer and to provide relevant advice and instruction in real-time or near real-time to the wearer of the vocational mask. The data that is collected may be used for inspection and future analyses of product quality, product design, and the like. Further, the collected data may be stored for instructional analyses and providing lessons, mentoring, collaboration, and the like.

The vocational mask may include one or more components (e.g., processing device, memory device, display, etc.), interfaces, and/or sensors configured to provide sensing capabilities to understand hand motions and use of a virtual user interface (e.g., keyboards) and other haptic instructions. The vocational mask may include a haptic interface to allow physical bidirectional haptic sensing and stimulation via the bidirectional communications to other users and/or collaborators using a peripheral haptic device (e.g., a welding gun).

In some embodiments, the vocational mask may be in the form of binocular goggles, monocular goggles, finishing process glasses (e.g., grind, chamfer, debur, sand polish, coat, etc.), or the like. The vocational mask may be attached to a welding helmet. The vocational mask may include an optical bench that aligns a virtual retinal display to one or more eyes of a user. The vocational mask may include a liquid crystal display welding helmet, a welding camera, an augmented reality/virtual reality headset, etc. The vocational mask may include a heads-up display configured to display information without requiring the user to look away or refocus.

The vocational mask may augment projections by providing augmented reality cues and information to assist a worker (e.g., welder) with contextual information, which may include setup, quality control, procedures, training, welding steps, best practices, and the like. Further, the vocational mask may provide a continuum of visibility from visible spectrum (arc off) through high intensity/ultraviolet (arc on). Further, some embodiments include remote feedback and recording of images and bidirectional communications to a trainer, supervisor, mentor, master user, teacher, collaborator, etc. who can provide visual, auditory, and/or haptic feedback to the wearer of the vocational mask in real-time or near real-time.

In some embodiments, the vocational mask may be integrated with a welding helmet. In some embodiments, the vocational mask may be a set of augmented reality/virtual reality goggles worn under a welding helmet (e.g., with external devices, sensors, cameras, etc. appended for image/data gathering). In some embodiments, the vocational mask may be a set of binocular welding goggles or a monocular welding goggle to be worn under or in lieu of a welding helmet (e.g., with external devices, sensors, cameras, etc. appended to the goggles for image/data gathering). In some embodiments, the vocational mask may include a mid-band or long wave context camera displayed to the user and monitor. In some embodiments, the vocational mask may be worn by a user that is operating a robotic unit from a remote location.

In some embodiments, information may be super positioned or superimposed onto a display without the user (e.g., worker, student, etc.) wearing a vocational mask. The information may include work instructions in the form of text, images, alphanumeric characters, video, etc. The vocational mask may function across both visible light (arc off) and high intensity ultraviolet light (arc on) conditions. The vocational mask may natively or in conjunction with other personal protective equipment provide protection against welding flash. The vocational mask may enable real-time or near real-time two-way communication with a remote instructor or supervisor. The vocational mask may provide one or more video, audio, and data feeds to a remote instructor or supervisor. The vocational mask and/or other components in a system may enable recording of all data and communications. The system may provide a mechanism for replaying the data and communications, via a media player, for training purposes, quality control purposes, inspection purposes, and the like. The vocational mask and/or other components in a system may provide a mechanism for visual feedback from a remote instructor or supervisor. The vocational mask and/or other components in a system may provide a bidirectional mechanism for haptic feedback from a remote instructor or supervisor.

Further, the system may include an artificial intelligence simulation generator that generates task simulations to be transmitted to and presented via the vocational mask. The simulation of a task may be transmitted as virtual reality data to the vocational mask which includes a virtual reality headset and/or display to playback the virtual reality data. The virtual reality data may be configured based on parameters of a physical space in which the vocational mask is located, based on parameters of an object to be worked on, based on parameters of a tool to be used, and the like.

Turning now to the figures, FIG. 1 depicts a system architecture 10 according to some embodiments. The system architecture 10 may include one or more computing devices 140, one or more vocational masks 130, one or more peripheral haptic devices 134, and/or one or more tools 136 communicatively coupled to a cloud-based computing system 116. Each of the computing devices 140, vocational masks 130, peripheral haptic devices 134, tools 136, and components included in the cloud-based computing system 116 may include one or more processing devices, memory devices, and/or network interface cards. The network interface cards may enable communication via a wireless protocol for transmitting data over short distances, such as Bluetooth, ZigBee, NFC, etc. Additionally, the network interface cards may enable communicating data over long distances, and in one example, the computing devices 140, the vocational masks 130, the peripheral haptic devices 134, the tools 136, and the cloud-based computing system 116 may communicate with a network 20. Network 20 may be a public network (e.g., connected to the Internet via wired (Ethernet) or wireless (Wi-Fi)), a private network (e.g., a local area network (LAN) or wide area network (WAN)), or a combination thereof. Network 20 may also include a node or nodes on the Internet of Things (IOT). The network 20 may be a cellular network.

The computing devices 140 may be any suitable computing device, such as a laptop, tablet, smartphone, smartwatch, ear buds, server, or computer. In some embodiments, the computing device 140 may be or be integrated within a vocational mask. The computing devices 140 may include a display capable of presenting a user interface 142 of an application. In some embodiments, the display may be a laptop display, smartphone display, computer display, tablet display, a virtual retinal display, etc. In some embodiments, the display may be a screen on the vocational mask, as described herein. The application may be implemented in computer instructions stored on the one or more memory devices of the computing devices 140 and executable by the one or more processing devices of the computing device 140. The application may present various screens to a user. For example, the user interface 142 may present a screen that plays video received from the vocational mask 130. The video may present real-time or near real-time footage of what the vocational mask 130 is viewing, and in some instances, that may include a user's hands holding the tool 136 to perform a task (e.g., weld, sand, polish, chamfer, debur, paint, play a video game, etc.). Additional screens may be presented via the user interface 142.

In some embodiments, the application (e.g., website) executes within another application (e.g., web browser). The computing device 140 may also include instructions stored on the one or more memory devices that, when executed by the one or more processing devices of the computing devices 140 perform operations of any of the methods described herein.

In some embodiments, the computing devices 140 may include an edge processor 132.1 that performs one or more operations of any of the methods described herein. The edge processor 132.1 may execute an artificial intelligence agent to perform various operations described herein. The artificial intelligence agent may include one or more machine learning models that are trained via the cloud-based computing system 116 as described herein. The edge processor 132.1 may represent one or more general-purpose processing devices such as a microprocessor, central processing unit, or the like. More particularly, the edge processor 132.1 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The edge processor 132.1 may also be one or more special-purpose processing devices such as an application specific integrated circuit (ASIC), a field programmable gate array (FPGA), a digital signal processor (DSP), network processor, or the like.

In some embodiments, the vocational mask 130 may be attached to or integrated with a welding helmet, binocular goggles, a monocular goggle, glasses, a hat, a helmet, a virtual reality headset, a headset, a facemask, or the like. The vocational mask 130 may include various components as described herein, such as an edge processor 132.2. In some embodiments, the edge processor 132.2 may be located separately from the vocational mask 130 and may be included in another computing device, such as a server, laptop, desktop, tablet, smartphone, etc. The edge processor 132.2 may represent one or more general-purpose processing devices such as a microprocessor, central processing unit, or the like. More particularly, the edge processor 132.2 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The edge processor 132.2 may also be one or more special-purpose processing devices such as an application specific integrated circuit (ASIC), a field programmable gate array (FPGA), a digital signal processor (DSP), network processor, or the like.

The edge processor 132.2 may perform one or more operations of any of the methods described herein. The edge processor 132.2 may execute an artificial intelligence agent to perform various operations described herein. The artificial intelligence agent may include one or more machine learning models that are trained via the cloud-based computing system 116 as described herein. For example, the cloud-based computing system 116 may train one or more machine learning models 154 via a training engine 152 and may transmit the parameters used to train the machine learning model to the edge processor 132.2 such that the edge processor 132.2 can implement the parameters in the machine learning models executing locally on the vocational mask 130 or computing device 140.

The edge processor 132.2 may include a data concentrator that collects data from multiple vocational masks 130 and transmits the data to the cloud-based computing system 116. The data concentrator may map information to reduce bandwidth transmission costs of transmitting data. In some embodiments, a network connection may not be needed for the edge processor 132.2 to collect data from vocational masks and to perform various functions using the trained machine learning models 154.

The vocational mask 130 may also include a network interface card that enables bidirectional communication with any other computing device 140, such as other vocational masks 130, smartphones, laptops, desktops, servers, wearable devices, tablets, etc. The vocational mask 130 may also be communicatively coupled to the cloud-based computing system 116 and may transmit and receive information and/or data to and from the cloud-based computing system 116. The vocational mask 130 may include various sensors, such as position sensors, acoustic sensors, haptic sensors, microphones, temperature sensors, accelerometers, and the like. The vocational mask 130 may include various cameras configured to capture audio and video. The vocational mask 130 may include a speaker to emit audio. The vocational mask 130 may include a haptic interface configured to transmit and receive haptic data to and from the peripheral haptic device 134. The haptic interface may be communicatively coupled to a processing device (e.g., edge processor 132.2) of the vocational mask 130.

In some embodiments, the vocational mask 130 includes one or more microphone connected to one or more of the processors described herein. For example, the microphone can detect, and capture sound emitted from a device that a user or a robot is performing work on (e.g., welding). The microphone generates sound data or audio signals associated with this event. An associated processor (e.g., edge processor 132.2) can be configured to execute audio signal processing on the detected audio signals. In embodiments, the processor executes a Fast Fourier Transform (FFT) or other audio signal processing technique. The detected audio signals may be represented in the time domain, where amplitude (loudness) is plotted against time. The FFT executed by the processor is configured to transform the audio signal from the time domain into the frequency domain, wherein instead of representing the signal in terms of time, it represents it in terms of frequency components. This allows the system to determine which frequencies are present in the signal and how strong they are. The FFT may output a frequency spectrum that represents the amplitudes of different frequency components present in the audio signal. The FFT allows the disclosed systems to detect the pitch, frequency, sound signatures, and the like of a component being worked on (e.g., welded).

In the context of welding for example, and as will be described further below, FFT or other audio processing techniques (e.g., wavelet transform, Mel-frequency cepstral coefficients (MFCC), time-domain analysis, etc.) can be used to analyze the audio signals captured by the microphone to identify specific sound signatures indicative of various welding conditions, such as the onset of a “burn through” in the weld. By converting the audio signals from the time domain to the frequency domain, FFT allows the processor to extract the frequency components associated with different welding phenomena such as burn through. A machine learning model 154 can then be trained (e.g., via training engine 152) using labeled audio data, where the presence or absence of a burn through is associated with specific frequency patterns extracted using FFT. That is, training data may include labeled inputs related to specific frequency patterns mapped to labeled outputs related to burn through probabilities, and the training data may be used to train the machine learning model 154. In some embodiments, an expert system, a deep learning algorithm, a neural network, or the like may be trained to detect burn through based on specific frequency patterns. Through this training process, the machine learning model 154 model learns to recognize distinctive sound signatures of a burn through. Once trained, the machine learning model 154 can be relied upon to process and monitor real-time audio signals during a weld such that a burn through or other phenomena can be detected in real time based on audio cues.

In embodiments, the system can react accordingly when a burn through or other phenomena is detected in real time. This may include automatically ceasing operation of a welding robot and/or allowing a human to take over the work task manually. In embodiments, the system can react by providing a warning to the user (e.g., welder), for example, by way of displaying information or providing other types of feedback disclosed herein on the vocational mask 130. In embodiments, the system can react by initiating a telework session in which a master worker can move a welding arm of a robot from a remote location, and the apprentice can view in real time the human intervention by the master worker, enabling the apprentice to learn proper welding techniques in real time to avoid burn through. In embodiments, the system can react by ceasing a telerobotic session. For example, a telerobotic session may include a human worker controlling a welding robot; if a burn through is detected based on the detected sound signature and execution of the machine learning model(s) 154, the telerobotic session can be automatically stopped, at which point a human worker (e.g., master) can take over the telerobotic session and the other human worker (e.g., apprentice) can visually and/or haptically (via peripheral haptic device 134) learn how to continue the weld to prevent the burn through.

In some embodiments, the peripheral haptic device 134 may be attached to or integrated with the tool 136. In some embodiments, the peripheral haptic device 134 may be separate from the tool 136. The peripheral haptic device 134 may include one or more haptic sensors that provide force, vibration, touch, and/or motion sensations to the user, among other things. The peripheral haptic device 134 may be used to enable a person (e.g., master) remote from a user (e.g., apprentice) of the peripheral haptic device 134 to provide haptic instructions to perform a task (e.g., weld, shine, polish, paint, control a video game controller, grind, chamfer, debur, etc.). The peripheral haptic device 134 may include one or more processing devices, memory devices, network interface cards, haptic interfaces, etc. In some embodiments, the peripheral haptic device 134 may be communicatively coupled to the vocational mask 130, the computing device 140, and/or the cloud-based computing system 116.

The tool 136 may be any suitable tool, such as a welding gun, a video game controller, a paint brush, a pen, a utensil, a grinder, a sander, a polisher, a gardening tool, a yard tool, a glove, or the like. The tool 136 may be handheld such that the peripheral haptic device 134 is enabled to provide haptic instructions for performing a task to the user holding the tool 136. In some embodiments, the tool 136 and/or the peripheral haptic device 134 may be wearable by the user. For example, the peripheral haptic device 134 may be or include a glove, arm, welding tool, or the like that can move in mimicked fashion related to the peripheral haptic device of a second user. The tool 136 may be used to perform a task. In some embodiments, the tool 136 may be located in a physical proximity to the user in a physical space.

In embodiments, the tool 136 can be manipulated remotely via the peripheral haptic device 134. For example, an apprentice can be wearing a glove, controlling a robot via a handle, and the like which can incorporate the peripheral haptic device. The master can remotely manipulate a similar device (e.g., glove, robot handle, etc.) that is communicatively coupled to the peripheral haptic device controlled or worn by the apprentice, thereby causing manipulation of the device controlled or worn by the apprentice. In short, the tool 136 controlled by the apprentice can be manipulated remotely by the master by way of peripheral haptic device 134 mirroring movements performed by the master.

In some embodiments, the cloud-based computing system 116 may include one or more servers 128 that form a distributed computing architecture. The servers 128 may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers 128 may include one or more processing devices, memory devices, data storage, and/or network interface cards. The servers 128 may be in communication with one another via any suitable communication protocol. The servers 128 may execute an artificial intelligence (AI) engine and/or an AI agent that uses one or more machine learning models 154 to perform at least one of the embodiments disclosed herein. The cloud-based computing system 116 may also include a database 129 that stores data, knowledge, and data structures used to perform various embodiments. For example, the database 129 may store multimedia data of users performing tasks using tools, communications between vocational masks 130 and/or computing devices 140, virtual reality simulations, augmented reality information, recommendations, instructions, and the like. The database 129 may also store user profiles including characteristics particular to each user. In some embodiments, the database 129 may be hosted on one or more of the servers 128.

In some embodiments the cloud-based computing system 116 may include a training engine 152 capable of generating the one or more machine learning models 154. The machine learning models 154 may be trained to identify perception-based objects and features using training data that includes labeled inputs of images including certain objects and features mapped to labeled outputs of identities or characterizations of those objects and features. The machine learning models 154 may be trained determine cognition-based scenery to identify one or more material defects, one or more assembly defects, one or more acceptable features, or some combination thereof using training data that includes labeled input of scenery images of objects including material defects, assembly defects, and/or acceptable features mapped to labeled outputs that characterize and/or identify the material defects, assembly defects, and/or acceptable features. The machine learning models 154 may be trained to determine one or more recommendations, instructions, or both using training data including labeled input of images (e.g., objects, products, tools, actions, etc.) and tasks to be performed (e.g., weld, grind, chamfer, debur, sand, polish, coat, etc.) mapped to labeled outputs including recommendations, instructions, or both. The machine learning models 154 may be trained to halt operation of a robot or tool, or cause a master to override or take control of the robot or tool, based on training data that includes labeled input of sound (e.g., associated with a burn through, etc.) and tasks to be performed (e.g., weld) mapped to labeled outputs such as halt operation of the robot or tool or cause a master to override or take control of the robot or tool. In some embodiments, an expert system, deep learning algorithm, neural network, or the like may also be trained similarly to the machine learning models 154.

The one or more machine learning models 154 may be generated by the training engine 152 and may be implemented in computer instructions executable by one or more processing devices of the training engine 152 and/or the servers 128. To generate the one or more machine learning models 154, the training engine 152 may train the one or more machine learning models 154. The one or more machine learning models 154 may also be executed by the edge processor 132 (132.1, 132.2). The parameters used to train the one or more machine learning models 154 by the training engine 152 at the cloud-based computing system 116 may be transmitted to the edge processor 132 (132.1, 132.2) to be implemented locally at the vocational mask 130 and/or the computing device 140.

The training engine 152 may be a rackmount server, a router computer, a personal computer, a portable digital assistant, a smartphone, a laptop computer, a tablet computer, a netbook, a desktop computer, an Internet of Things (IOT) device, any other desired computing device, or any combination of the above. The training engine 152 may be cloud-based, be a real-time software platform, include privacy software or protocols, and/or include security software or protocols. To generate the one or more machine learning models 154, the training engine 152 may train the one or more machine learning models 154.

The one or more machine learning models 154 may refer to model artifacts created by the training engine 152 using training data that includes training inputs and corresponding target outputs. The training engine 152 may find patterns in the training data wherein such patterns map the training input to the target output and generate the machine learning models 154 that capture these patterns. Although depicted separately from the server 128, in some embodiments, the training engine 152 may reside on server 128. Further, in some embodiments, the database 129, and/or the training engine 152 may reside on the computing devices 140.

As described in more detail below, the one or more machine learning models 154 may comprise, e.g., a single level of linear or non-linear operations (e.g., a support vector machine [SVM]) or the machine learning models 154 may be a deep network, i.e., a machine learning model comprising multiple levels of non-linear operations. Examples of deep networks are neural networks, including generative adversarial networks, convolutional neural networks, recurrent neural networks with one or more hidden layers, and fully connected neural networks (e.g., each neuron may transmit its output signal to the input of the remaining neurons, as well as to itself). For example, the machine learning model may include numerous layers and/or hidden layers that perform calculations (e.g., dot products) using various neurons.

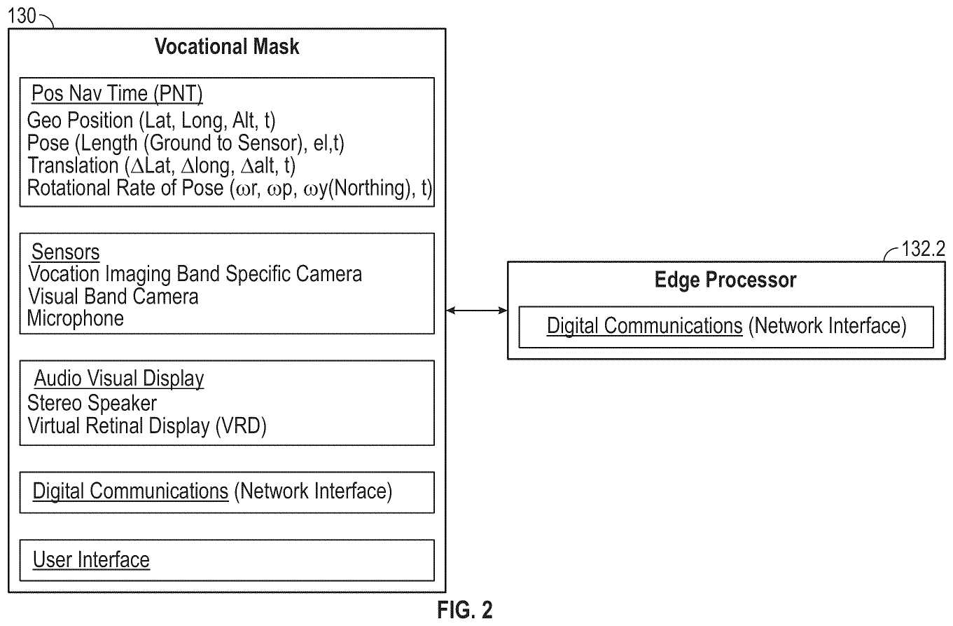

FIG. 2 illustrates a component diagram for a vocational mask 130 according to certain embodiments of this disclosure. The edge processor 132.2 is also depicted. In some embodiments, the edge processor 132.2 may be included in a computing device separate from the vocational mask 130, and in some embodiments, the edge processor 132.2 may be included in the vocational mask 130.

The vocational mask 130 may include various position, navigation, and time (PNT) components, sensors, and/or devices that enable determining the geographical positon (latitude, longitude, altitude, time), pose (length (ground to sensor), elevation, time), translation (delta in latitude, delta in longitude, delta in altitude, time), the rotational rate of pose (ωᵣ, ωₚ, ω_{y} (northing), t), and the like, where wr represents the roll rate, which is the angular velocity about the longitudinal axis of the vocational mask 130, ωₚ represents the pitch rate, which is the angular velocity about the lateral axis of the vocational mask 130, ω_{y} (northing) represents the yaw rate, which is the angular velocity about the vertical axis of the vocational mask 130, referenced with respect to the northing direction, and t represents the time at which these rotational rates are measured.

In some embodiments, the vocational mask 130 may include one or more sensors, such as vocation imaging band specific cameras, visual band cameras, microphones, and the like.

In some embodiments, the vocational mask 130 may include an audio-visual display, such as a stereo speaker, a virtual retinal display, a liquid crystal display, a virtual reality headset, a heads-up display, and the like. A virtual retinal display may be a retinal scan display or retinal projector that draws a raster display directly onto the retina of the eye. In some embodiments, the virtual retinal display may include drive electronics that transmit data to a photon generator and/or intensity modulator. These components may process the data (e.g., video, audio, haptic, etc.) and transmit the processed data to a beam scanning component that further transmits data to an optical projector that projects an image and/or video to a retina of a user.

In some embodiments, the vocational mask 130 may include a network interface card that enables bidirectional communication (digital communication) with other vocational masks and/or computing device 140.

In some embodiments, the vocational mask 130 may provide a user interface to the user via the display described herein.

In some embodiments, the edge processor 132.2 may include a network interface card that enables digital communication with the vocational mask 130, the computing device 140, the cloud-based computing system 116, or the like.

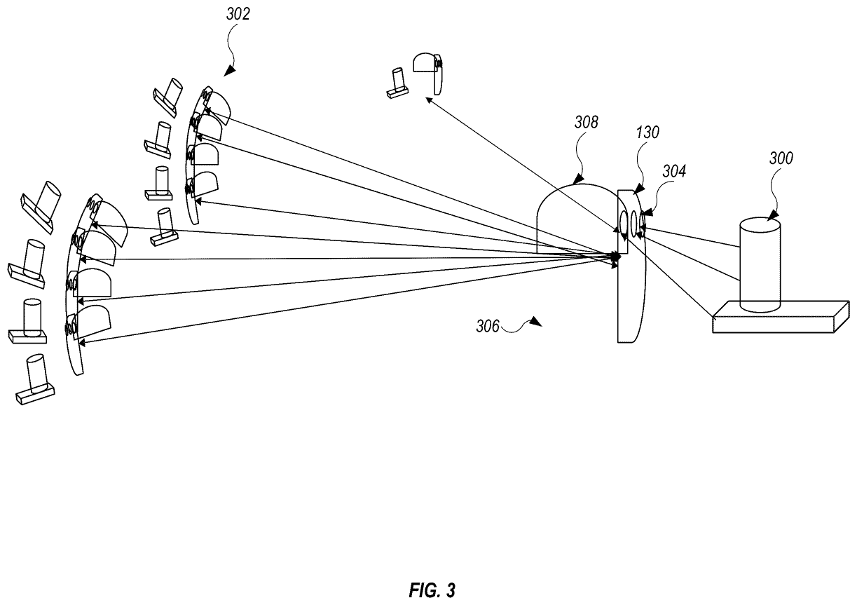

FIG. 3 illustrates bidirectional communication between communicatively coupled vocational masks 130 according to certain embodiments of this disclosure. As depicted, a user 306 is wearing a vocational mask 130. In the depicted example, the vocational mask 130 is attached to or integrated with a welding helmet 308. The user is viewing an object 300. The vocational mask 130 may include multiple electromagnetic spectrums and/or acoustic sensors/imagers 304 to enable obtaining audio, video, acoustic, etc. data while observing the object 300 and/or performing a task (e.g., welding).

Further, as depicted, the vocational mask 130 may be communicatively coupled to one or more other vocational masks 302 worn by other users and may communicate data in real-time or near real-time such that bidirectional audio visual and haptic communications foster a master-apprentice relationship. In some embodiments, the bidirectional communication enabled by the vocational masks 130 may enable collaboration between a teacher or collaborator and students. Each of the users wearing the vocational mask 130 may be enabled to visualize the object 300 that the user is viewing in real-time or near real-time. Moreover, a tool manipulated by the master can also cause a corresponding tool to be manipulated by the apprentice via haptic communication.

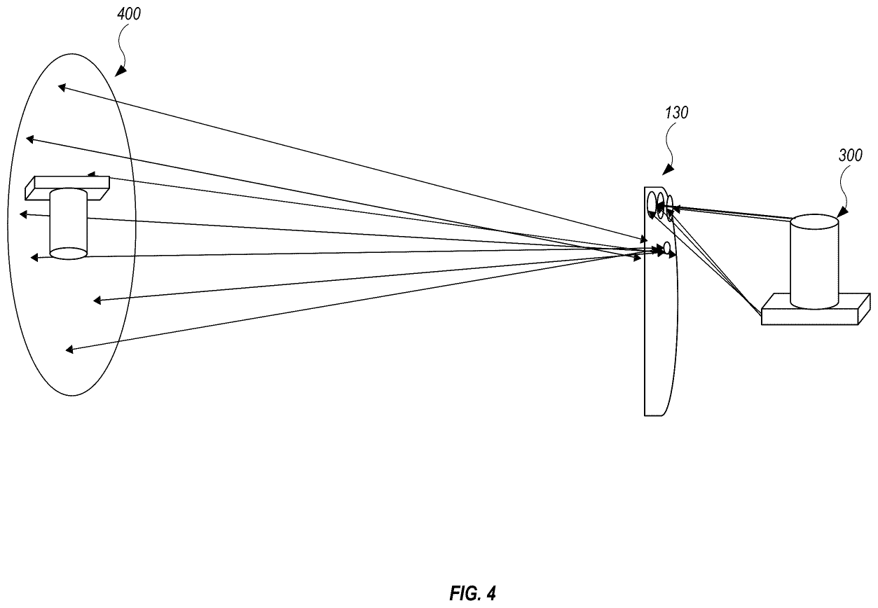

FIG. 4 illustrates an example of projecting an image onto a user's retina 400 via a virtual retinal display of a vocational mask 130 according to certain embodiments of this disclosure. As depicted, the imagers and/or cameras of the vocational mask 130 receive data pertaining to the object and the vocational mask 130 processes the data and projects an image representing the object 300 using a virtual retinal display onto the user's retina 400. The bidirectional communication with other users (e.g., students, master user, collaborator, teacher, supervisor, etc.) may enable projecting the image onto their retinas if they are wearing a vocational mask, as well. In some embodiments, the image may be displayed via a computing device 140 if the other users are not wearing vocational masks.

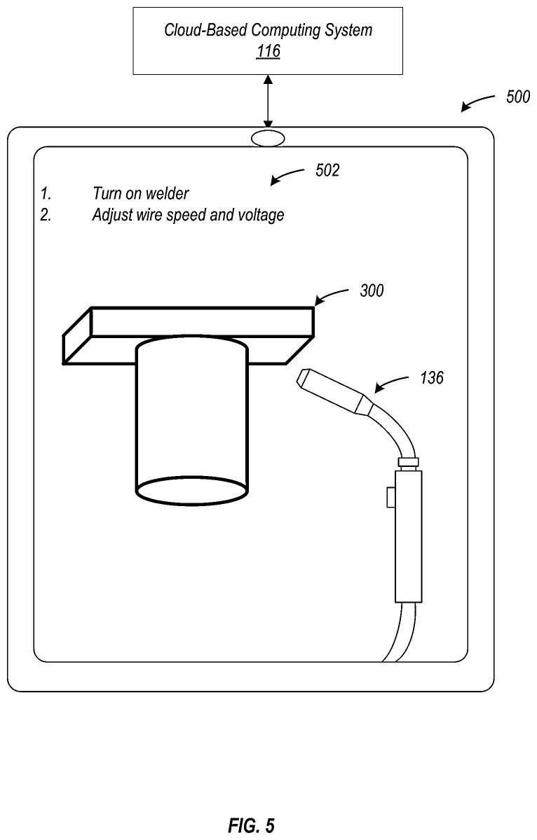

FIG. 5 illustrates an example of an image including instructions projected via a display (e.g., virtual retinal display) of a vocational mask 130 according to certain embodiments of this disclosure. The example user interface 500 depicts actual things the user is looking at, such as a tool 136 and an object 300, through the vocational mask 130. Further, the user interface depicts instructions 502 pertaining to performing a task. The instructions 502 may be generated by one or more machine learning models 154 of the AI agent or may be provided via a computing device 140 and/or another vocational mask being used by another user (e.g., master user, collaborator, teacher, supervisor, etc.). In the depicted example, the instructions 502 instruct the user to “1. Turn on welder; 2. Adjust wire speed and voltage”. The instructions 502 may be projected on the user's retina via the virtual retinal display and/or presented on a display of the vocational mask 130. The instructions can be overlaid or otherwise displayed along with the user's real-world view of the tool 136 and object 300.

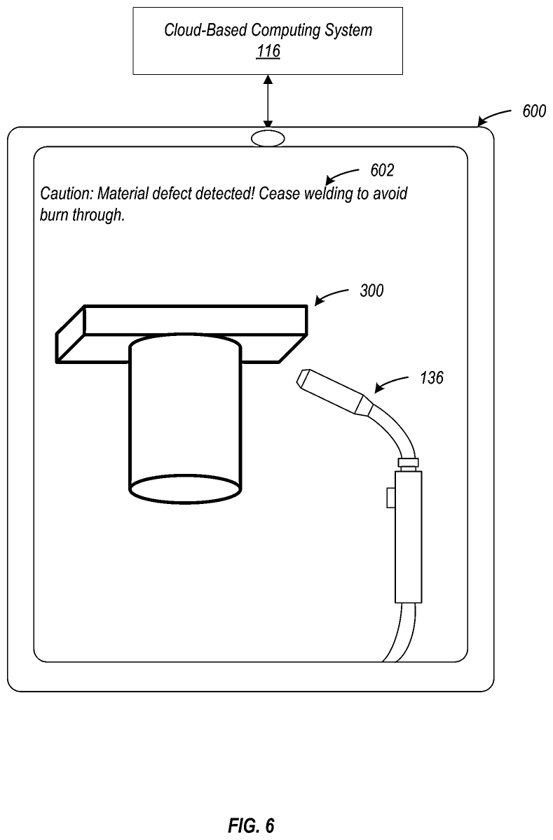

FIG. 6 illustrates an example of an image including a warning projected via a display (e.g., virtual retinal display) of a vocational mask according to certain embodiments of this disclosure. The example user interface 600 depicts actual things the user is looking at, such as a tool 136 and an object 300, through the vocational mask 130. Further, the user interface depicts a warning 602 pertaining to performing a task. The warning 602 may be generated by one or more machine learning models 154 of the AI agent or may be provided via a computing device 140 and/or another vocational mask being used by another user (e.g., master user, collaborator, teacher, supervisor, etc.). In the depicted example, the warning 602 indicates “Caution: Material defect detected! Cease welding to avoid burn through”. The warning 602 may be projected on the user's retina via the virtual retinal display and/or presented on a display of the vocational mask 130. In embodiments, this warning is provided in response to the execution of the machine learning model 154 indicating the likelihood of a burn through being reached or approaching based on the sound signatures of the material during the welding.

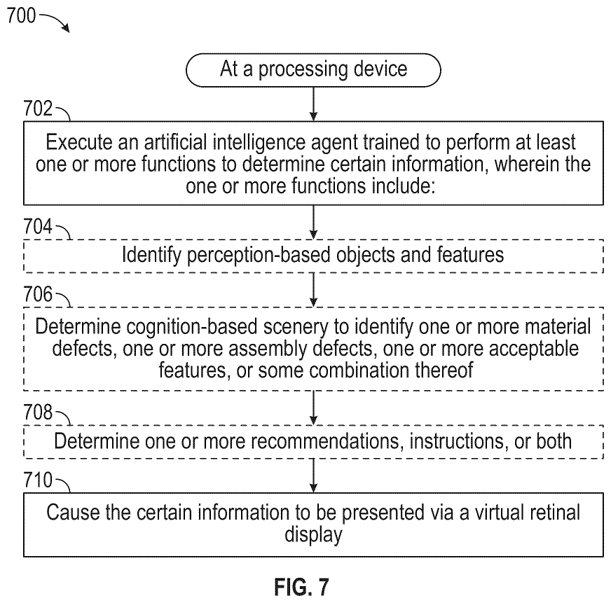

FIG. 7 illustrates an example of a method 700 for executing an artificial intelligence agent to determine certain information projected via a vocational mask of a user according to certain embodiments of this disclosure. The method 700 may be performed by processing logic that may include hardware (circuitry, dedicated logic, etc.), software, or a combination of both. The method 700 and/or each of their individual functions, subroutines, or operations may be performed by one or more processing devices of a computing device (e.g., any component (server 128, training engine 152, machine learning models 154, etc.) of cloud-based computing system 116, vocational mask 130, edge processor 132 (132.1, 132.2), peripheral haptic device 134, tool 136, and/or computing device 140 of FIG. 1) implementing the method 700. The method 700 may be implemented as computer instructions stored on a memory device and executable by the one or more processors. In certain implementations, the method 700 may be performed by a single processing thread. Alternatively, the method 700 may be performed by two or more processing threads, each thread implementing one or more individual functions, routines, subroutines, or operations of the methods.

For simplicity of explanation, the method 700 is depicted and described as a series of operations. However, operations in accordance with this disclosure can occur in various orders or concurrently, and with other operations not presented and described herein. For example, the operations depicted in the method 700 may occur in combination with any other operation of any other method disclosed herein. Furthermore, not all illustrated operations may be required to implement the method 700 in accordance with the disclosed subject matter. In addition, those skilled in the art will understand and appreciate that the method 700 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include several nodes included in each layer of the machine learning models, an objective function executed at each node, a number of layers, various weights associated with outputs of each node, and the like.

In some embodiments, a system may include the vocational mask 130, which may include one or more virtual retinal displays, memory devices, processing devices, and other components as described herein. The processing devices may be communicatively coupled to the memory devices that store computer instructions, and the processing devices may execute the computer instructions to perform one or more of the steps of the method 700. In some embodiments, the system may include a welding helmet, and the vocational mask may be coupled to the welding helmet. In some embodiments, the vocational mask may be configured to operate across both visible light and high intensity ultraviolet light conditions. In some embodiments, the vocational mask may provide protection against welding flash. In some embodiments, the vocational mask may be integrated with goggles. In some embodiments, the vocational mask may be integrated with binoculars or a monocular.

At block 702, the processing device may execute an artificial intelligence agent trained to perform at least one or more functions to determine certain information. The functions may include (i) identifying perception-based objects and features 704, (ii) determining cognition-based scenery to identify one or more material defects, one or more assembly defects, one or more acceptable features, or some combination thereof 706, and (iii) determining one or more recommendations, instructions, or both 708.

The artificial intelligence agent may include one or more machine learning models 154 trained to perform the functions. For example, at block 704, one or more machine learning models 154 may be trained to (i) identify perception-based objects and features using training data that includes labeled inputs of images including certain objects and features mapped to labeled outputs of identities or characterizations of those objects and features. The machine learning models may be trained to analyze aspects of the objects and features to compare the aspects to known aspects associated with known objects and features, and the machine learning models may perceive the identity of the analyzed objects and features. In other embodiments, one or more machine learning models 154 may be trained to (i) identify sound signatures (e.g., frequencies, amplitudes, etc.) associated with a burn through being reached or approaching using training data that includes labeled inputs of audio segments including certain burn through events mapped to labeled outputs of identities or characteristics of those outputs and features. The machine learning models may be trained to analyze aspects of the sound to compare the aspects to known aspects associated with known weld characteristics (e.g., burn through).

As indicated at block 706, the one or more machine learning models 154 may also be trained to (ii) determine cognition-based scenery or audio-based cues to identify one or more material defects, one or more assembly defects, one or more acceptable features, one or more work characteristics such as burn through, or some combination thereof using training data that includes labeled input of scenery images or audio of objects including material defects, assembly defects, work characteristics and/or acceptable features mapped to labeled outputs that characterize and/or identify the material defects, assembly defects, work characteristics and/or acceptable features. For example, one scenery image may include a portion of a submarine that includes parts that are welded together, and the machine learning models may be trained to cognitively analyze the scenery image to identify one or more portions of the scenery image that includes a welded part with a material welding defect, a part assembly defect, and/or acceptable welded feature. In embodiments, one audio segment may include sound that indicates a burn through, and the machine learning models may be trained to cognitively analyze the audio segments to identify one or more portions of audio segments that indicates a burn through.

As indicated at block 708, the one or more machine learning models 154 may be trained to (iii) determine one or more recommendations, instructions, or both using training data including labeled input of images (e.g., objects, products, tools, actions, etc.) and tasks to be performed (e.g., weld, grind, chamfer, debur, sand, polish, coat, etc.) mapped to labeled outputs including recommendations, instructions, or both. The processing device may provide (e.g., via the virtual retinal display, a speaker, etc.) images, video, and/or audio that points out the defects and provides instructions, drawings, and/or information pertaining to how to fix the defects.

In addition, the output from performing one of the functions (i), (ii), and/or (iii) may be used as input to the other functions to enable the machine learning models 154 to generate a combined output. For example, the machine learning models 154 may identify a defect (a gouge) and provide welding instructions on how to fix the defect by filling the gouge properly via the vocational mask 130. Further, in some instances, the machine learning models 154 may identify several potential actions that the user can perform to complete the task and may aid the user's decision making by providing the actions in a ranked order of most preferred action to least preferred action or a ranked order of the action with the highest probability of success to the action with the lowest probability of success. In some embodiments, the machine learning models 154 may identify an acceptable feature (e.g., properly welded parts) and may output a recommendation to do nothing.

As indicated at block 710, the processing device may cause the certain information to be presented via the display, e.g. virtual retinal display. In some embodiments, the display may project an image onto at least one iris of the user to display alphanumeric data, graphic instructions, animated instructions, video instructions, or some combination thereof. In some embodiments, the vocational mask may include a stereo speaker to emit audio pertaining the information. In some embodiments, the processing device may superposition the certain information on a display (e.g., virtual retinal display).

In some embodiments, the vocational mask may include a network interface configured to enable bidirectional communication with a second network interface of a second vocational mask. The bidirectional communication may enable transmission of real-time or near real-time audio and video data, recorded audio and video data, or some combination thereof. “Real-time” may refer to less than 2 seconds and “near real-time” may refer to between 2 and 20 seconds.

In some embodiments, in addition to the vocational mask, a system may include a peripheral haptic device. The vocational mask may include a haptic interface, and the haptic interface may be configured to perform bidirectional haptic sensing and stimulation using the peripheral haptic device and the bidirectional communication. The stimulation may include precise mimicking, vibration, and the like. For example, the stimulation may include performing mimicked gestures via the peripheral haptic device. In other words, a master user may be using a peripheral haptic device to perform a task and the gestures performed by the master user using the peripheral haptic device may be mimicked by the peripheral haptic device being used by an apprentice user. In such a way, the master user may train and/or guide the apprentice user how to properly perform a task (e.g., weld) using the peripheral haptic devices.

The haptic interface may be communicatively coupled to the processing device. The haptic interface may be configured to sense, from the peripheral haptic device, hand motions, texture, temperature, vibration, slipperiness, friction, wetness, pulsation, stiction, friction, and the like. For example, the haptic interface may detect keystrokes when a user uses a virtual keyboard presented via the vocational mask using a display (e.g., virtual retinal display).

Further, the bidirectional communication provided by the vocational mask(s) and/or computing devices may enable a master user of a vocational mask and/or computing device to view and/or listen to the real-time or near real-time audio and video data, recorded audio and video data, or some combination thereof, and to provide instructions to the user via the vocational mask being worn by the user. In some embodiments, the bidirectional communication provided by the vocational mask(s) and/or computing devices may enable the user of a vocational mask and/or computing device to provide instructions to a set of students and/or apprentices via multiple vocational masks being worn by the students and/or apprentices. This technique may be beneficial for a teacher, collaborator, master user, and/or supervisor that is training the set of students.

In some embodiments, the user wearing a vocational mask may communicate with one or more users who are not wearing a vocational mask. For example, a teacher and/or collaborator may be using a computing device (e.g., smartphone) to see what a student is viewing and hear what the student is hearing using the bidirectional communication provided by the vocational mask worn by the student. The bidirectional communication provided by the vocational mask may enable a teacher or collaborator to receive, using a computing device, audio data, video data, haptic data, or some combination thereof, from the vocational mask being used by the user.

Additionally, the teacher and/or collaborator may receive haptic data, via the computing device, from the vocational mask worn by the student. The teacher and/or collaborator may transmit instructions (e.g., audio, video, haptic, etc.), via the computing device, to the vocational mask to guide and/or teach the student how to perform the task (e.g., weld) in real-time or near real-time.

In another example, the bidirectional communication may enable a user wearing a vocational mask to provide instructions to a set of students via a set of computing devices (e.g., smartphones). In this example, the user may be a teacher or collaborator and may be teaching a class or lesson on how to perform a task (e.g., weld) while wearing the vocational mask.

In some embodiments, the vocational mask may include one or more sensors to provide information related to geographical position, pose of the user, rotational rate of the user, or some combination thereof. In some embodiments, a position sensor may be used to determine a location of the vocational mask, an object, a peripheral haptic device, a tool, etc. in a physical space. The position sensor may determine an absolute position in relation to an established reference point. In some embodiments, the processing device may perform physical registration of the vocational mask, an object being worked on, a peripheral haptic device, a tool (e.g., welding gun, sander, grinder, etc.), etc. to map out the device in an environment (e.g., warehouse, room, underwater, etc.) in which the vocational mask, the object, the peripheral haptic device, etc. is located.

In some embodiments, the vocational mask may include one or more sensors including vocation imaging band specific cameras, visual band cameras, stereo microphones, acoustic sensors, or some combination thereof. The acoustic sensors may sense welding clues based on audio signatures associated with certain defects or issues, such as burn through. Machine learning models 154 may be trained using inputs of labeled audio signatures, labeled images, and/or labeled videos mapped to labeled outputs of defects. The artificial intelligence agent may process received sensor data, such as images, audio, video, haptics, etc., identify an issue (e.g., defect), and provide a recommendation (e.g., stop welding due to detected potential burn through) via the vocational mask.

In some embodiments, the vocational mask may include an optical bench that aligns the virtual retinal display to one or more eyes of the user.

In some embodiments, the processing device is configured to record the certain information, communications with other devices (e.g., vocational masks, computing devices), or both. The processing device may store certain information and/or communications as data in the memory device communicatively coupled to the processing device, and/or the processing device may transmit the certain information and/or communications as data feeds to the cloud-based computing system 116 for storage.

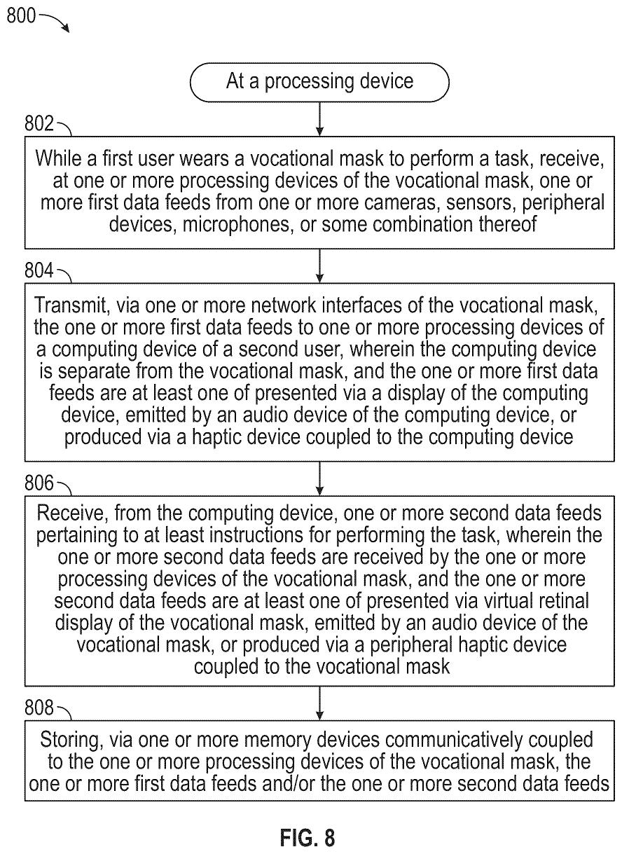

FIG. 8 illustrates an example of a method 800 for transmitting instructions for performing a task via bidirectional communication between a vocational mask and a computing device according to certain embodiments of this disclosure. The method 800 may be performed by processing logic that may include hardware (circuitry, dedicated logic, etc.), software, or a combination of both. The method 800 and/or each of their individual functions, subroutines, or operations may be performed by one or more processing devices of a computing device (e.g., any component (server 128, training engine 152, machine learning models 154, etc.) of cloud-based computing system 116, vocational mask 130, edge processor 132 (132.1, 132.2), peripheral haptic device 134, tool 136, and/or computing device 140 of FIG. 1) implementing the method 700. The method 800 may be implemented as computer instructions stored on a memory device and executable by the one or more processors. In certain implementations, the method 800 may be performed by a single processing thread. Alternatively, the method 800 may be performed by two or more processing threads, each thread implementing one or more individual functions, routines, subroutines, or operations of the methods.

For simplicity of explanation, the method 800 is depicted and described as a series of operations. However, operations in accordance with this disclosure can occur in various orders or concurrently, and with other operations not presented and described herein. For example, the operations depicted in the method 800 may occur in combination with any other operation of any other method disclosed herein. Furthermore, not all illustrated operations may be required to implement the method 800 in accordance with the disclosed subject matter. In addition, those skilled in the art will understand and appreciate that the method 800 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

At block 802, while a first user wears a vocational mask 130 to perform a task, the processing device may receive, at one or more processing devices of the vocational mask 130, one or more first data feeds from one or more cameras of the vocational mask 130, sensors of the vocational mask 130, peripheral haptic devices associated with the vocational mask 130, microphones of the vocational mask 130, or some combination thereof. In some embodiments, the vocational mask 130 may be attached to or integrated with a welding helmet and the task may be welding. In some embodiments, the task may be sanding, grinding, polishing, deburring, chamfering, coating, etc. The vocational mask 130 may be attached to or integrated with a helmet, a hat, goggles, binoculars, a monocular, or the like.

In some embodiments, the one or more first data feeds may include information related to video, images, audio, hand motions, haptics, texture, temperature, vibration, slipperiness, friction, wetness, pulsation, or some combination thereof. In some embodiments, the one or more first data feeds may include geographical position of the vocational mask 130, and the processing device may map, based on the geographical positon, the vocational mask 130 in an environment or a physical space in which the vocational mask 130 is located.

At block 804, the processing device may transmit, via one or more network interfaces of the vocational mask 130, the one or more first data feeds to one or more processing devices of the computing device 140 of a second user. In some embodiments, the computing device 140 of the second user may include one or more vocational masks, one or more smartphones, one or more tablets, one or more laptop computers, one or more desktop computers, one or more servers, or some combination thereof. The computing device 140 may be separate from the vocational mask 130, and the one or more first data feeds are at least one of presented via a display of the computing device 140, emitted by an audio device of the computing device 140, or produced or reproduced via a peripheral haptic device coupled to the computing device 140. In some embodiments, the first user may be an apprentice, student, trainee, or the like, and the second user may be a master user, a trainer, a teacher, a collaborator, a supervisor, or the like.

At block 806, the processing device may receive, from the computing device, one or more second data feeds pertaining to at least instructions for performing the task. The one or more second data feeds are received by the one or more processing devices of the vocational mask 130, and the one or more second data feeds are at least one of presented via a virtual retinal display of the vocational mask 130, emitted by an audio device (e.g., speaker) of the vocational mask 130, or produced or reproduced via a peripheral haptic device 134 coupled to the vocational mask 130.

In some embodiments, the instructions are presented, by the virtual retinal display of the vocational mask 130, via augmented reality. In some embodiments, the instructions are presented, by the virtual retinal display of the vocational mask, via virtual reality during a simulation associated with the task. In some embodiments, the processing device may cause the virtual retinal display to project an image onto at least one iris of the first user to display alphanumeric data associated with the instructions, graphics associated with the instructions, animations associated with the instructions, video associated with the instructions, or some combination thereof.

At block 808, the processing device may store, via one or more memory devices communicatively coupled to the one or more processing devices of the vocational mask 130, the one or more first data feeds and/or the one or more second data feeds.

In some embodiments, the processing device may cause the peripheral haptic device 134 to vibrate based on the instructions received from the computing device 140.

In some embodiments, the processing device may execute an artificial intelligence agent trained to perform at least one or more functions to determine certain information. The one or more functions may include (i) identifying perception-based objects and features, (ii) determining cognition-based scenery to identify one or more material defects, one or more assembly defects, one or more acceptable features, or some combination thereof, and (iii) determining one or more recommendations, instructions, or both.

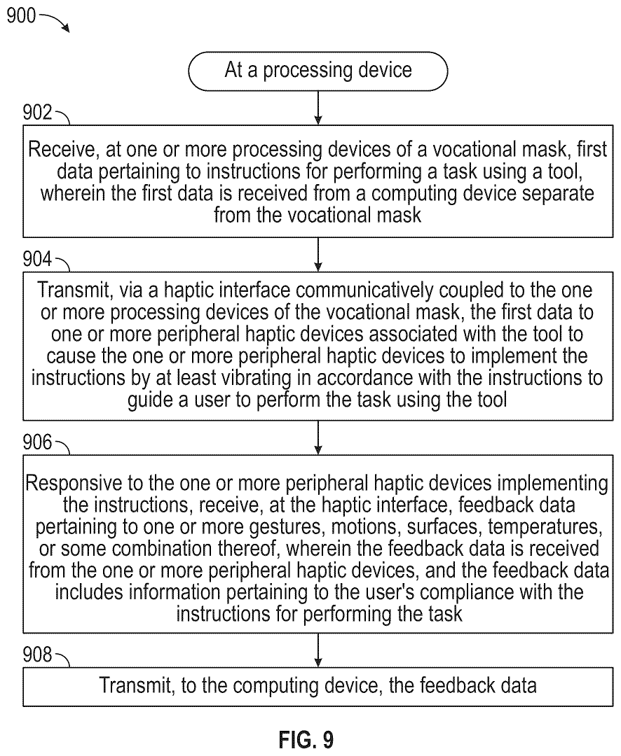

FIG. 9 illustrates an example of a method 900 for implementing instructions for performing a task using a peripheral haptic device according to certain embodiments of this disclosure. The method 900 may be performed by processing logic that may include hardware (circuitry, dedicated logic, etc.), software, or a combination of both. The method 900 and/or each of their individual functions, subroutines, or operations may be performed by one or more processing devices of a computing device (e.g., any component (server 128, training engine 152, machine learning models 154, etc.) of cloud-based computing system 116, vocational mask 130, edge processor 132 (132.1, 132.2), peripheral haptic device 134, tool 136, and/or computing device 140 of FIG. 1) implementing the method 900. The method 900 may be implemented as computer instructions stored on a memory device and executable by the one or more processors. In certain implementations, the method 900 may be performed by a single processing thread. Alternatively, the method 900 may be performed by two or more processing threads, each thread implementing one or more individual functions, routines, subroutines, or operations of the methods.

For simplicity of explanation, the method 900 is depicted and described as a series of operations. However, operations in accordance with this disclosure can occur in various orders or concurrently, and with other operations not presented and described herein. For example, the operations depicted in the method 900 may occur in combination with any other operation of any other method disclosed herein. Furthermore, not all illustrated operations may be required to implement the method 900 in accordance with the disclosed subject matter. In addition, those skilled in the art will understand and appreciate that the method 900 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include a number of nodes included in each layer of the machine learning models, an objective function executed at each node, a number of layers, various weights associated with outputs of each node, and the like.

At block 902, the processing device may receive, at one or more processing devices of a vocational mask 130, first data pertaining to instructions for performing a task using a tool 136. The first data may be received from a computing device 140 separate from the vocational mask 130. In some embodiments, the computing device may include one or more peripheral haptic devices, one or more vocational masks, one or more smartphones, one or more tablets, one or more laptop computers, one or more desktop computers, one or more servers, or some combination thereof. In some embodiments, the task includes welding and the tool 136 is a welding gun.

At block 904, the processing device may transmit, via a haptic interface communicatively coupled to the one or more processing devices of the vocational mask 130, the first data to one or more peripheral haptic devices 134 associated with the tool 136 to cause the one or more peripheral haptic devices 134 to implement the instructions by at least vibrating in accordance with the instructions to guide a user to perform the task using the tool 136.

At block 906, responsive to the one or more peripheral haptic devices 134 implementing the instructions, the processing device may receive, from a haptic interface, feedback data pertaining to one or more gestures, motions, surfaces, temperatures, or some combination thereof. The feedback data may be received from the one or more peripheral haptic devices 134, and the feedback data may include information pertaining to the user's compliance with the instructions for performing the task.

At block 908, the processing device may transmit to the computing device 140, the feedback data. In some embodiments, transmitting the feedback data may cause the computing device 140 to produce an indication of whether the user complied with the instructions for performing the task. The indication may be produced or generated via a display, a speaker, a different peripheral haptic device, or some combination thereof.

In some embodiments, in addition to the first data being received, video data may be received at the processing device of the vocational mask 130, and the video data may include video pertaining to the instructions for performing the task using the tool 136. In some embodiments, the processing device may display, via a virtual retinal display of the vocational mask 130, the video data. In some embodiments, the video data may be displayed concurrently with the instructions being implemented by the one or more peripheral haptic devices 134.

In some embodiments, in addition to the first data and/or video data being received, audio data may be received at the processing device of the vocational mask 130, and the audio data may include audio pertaining to the instructions for performing the task using the tool 136. In some embodiments, the processing device may emit, via a speaker of the vocational mask 130, the audio data. In some embodiments, the audio data may be emitted concurrently with the instructions being by the one or more peripheral haptic devices 134 and/or with the video data being displayed by the virtual retinal display. That is, one or more of video, audio, and/or haptic data pertaining to the instructions may be used concurrently to guide or instruct a user how to perform a task.

In some embodiments, in addition to the first data, video data, and/or audio data being received, virtual reality data may be received at the processing device of the vocational mask 130, and the virtual reality data may include virtual reality multimedia representing a simulation of a task. The processing device may execute, via at least a display of the vocational mask 130, playback of the virtual reality multimedia. For example, an artificial intelligent simulation generator may be configured to generate a virtual reality simulation for performing a task, such as welding an object using a welding gun. The virtual reality simulation may take into consideration various attributes, characteristics, parameters, and the like of the welding scenario, such as type of object being welded, type of welding, current amperage, length of arc, angle, manipulation, speed, and the like. The virtual reality simulation may be generated as multimedia that is presented via the vocational mask to a user to enable a user to practice, visualize, and experience performing certain welding tasks without actually welding anything.

In some embodiments, in addition to the first data, video data, audio data, and/or virtual reality data being received, augmented reality data may be received at the processing device of the vocational mask 130, and the augmented reality data may include augmented reality multimedia representing at least the instructions (e.g., via text, graphics, images, video, animation, audio). The processing device may execute, via at least a display of the vocational mask 130, playback of the augmented reality multimedia.

In some embodiments, the processing device may execute an artificial intelligence agent trained to perform at least one or more functions to determine certain information. The one or more functions may include (i) identifying perception-based objects and features, (ii) determining cognition-based scenery to identify one or more material defects, one or more assembly defects, one or more acceptable features, or some combination thereof, and/or (iii) determining one or more recommendations, instructions, or both. In some embodiments, the processing device may display, via a display (e.g., virtual retinal display or other display), the objects and features, the one or more material defects, the one or more assembly defects, the one or more acceptable features, the one or more recommendations, the instructions, or some combination thereof.

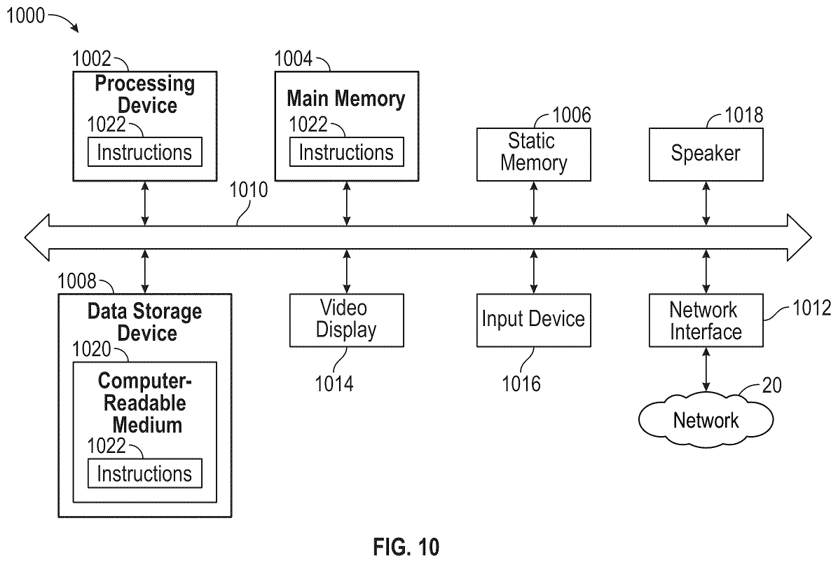

FIG. 10 illustrates an example computer system 1000, which can perform any one or more of the methods described herein. In one example, computer system 1000 may include one or more components that correspond to the vocational mask 130, the computing device 140, the peripheral haptic device 134, the tool 136, the robotic unit, one or more servers 128 of the cloud-based computing system 116, or one or more training engines 152 of the cloud-based computing system 116 of FIG. 1. The computer system 1000 may be connected (e.g., networked) to other computer systems in a LAN, an intranet, an extranet, or the Internet. The computer system 1000 may operate in the capacity of a server in a client-server network environment. The computer system 1000 may be a personal computer (PC), a tablet computer, a laptop, a wearable (e.g., wristband), a set-top box (STB), a personal Digital Assistant (PDA), a smartphone, a smartwatch, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 1000 includes a processing device 1002, a main memory 1004 (e.g., read-only memory (ROM), solid state drive (SSD), flash memory, dynamic random access memory (DRAM) such as synchronous DRAM (SDRAM)), a static memory 1006 (e.g., solid state drive (SSD), flash memory, static random access memory (SRAM)), and a data storage device 1008, which communicate with each other via a bus 1010.

Processing device 1002 represents one or more general-purpose processing devices such as a microprocessor, central processing unit, or the like. More particularly, the processing device 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1002 may also be one or more special-purpose processing devices such as an application specific integrated circuit (ASIC), a field programmable gate array (FPGA), a digital signal processor (DSP), network processor, or the like. The processing device 1002 is configured to execute instructions for performing any of the operations and steps of any of the methods discussed herein.

The computer system 1000 may further include a network interface device 1012. The computer system 1000 also may include a video display 1014 (e.g., a liquid crystal display (LCD) or a cathode ray tube (CRT)), one or more input devices 1016 (e.g., a keyboard and/or a mouse), and one or more speakers 1018 (e.g., a speaker). In one illustrative example, the video display 1014 and the input device(s) 1016 may be combined into a single component or device (e.g., an LCD touch screen).

The data storage device 1008 may include a computer-readable medium 1020 on which the instructions 1022 embodying any one or more of the methodologies or functions described herein are stored. The instructions 1022 may also reside, completely or at least partially, within the main memory 1004 and/or within the processing device 1002 during execution thereof by the computer system 1000. As such, the main memory 1004 and the processing device 1002 also constitute computer-readable media. The instructions 1022 may further be transmitted or received over a network 20 via the network interface device 1012.

While the computer-readable storage medium 1020 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

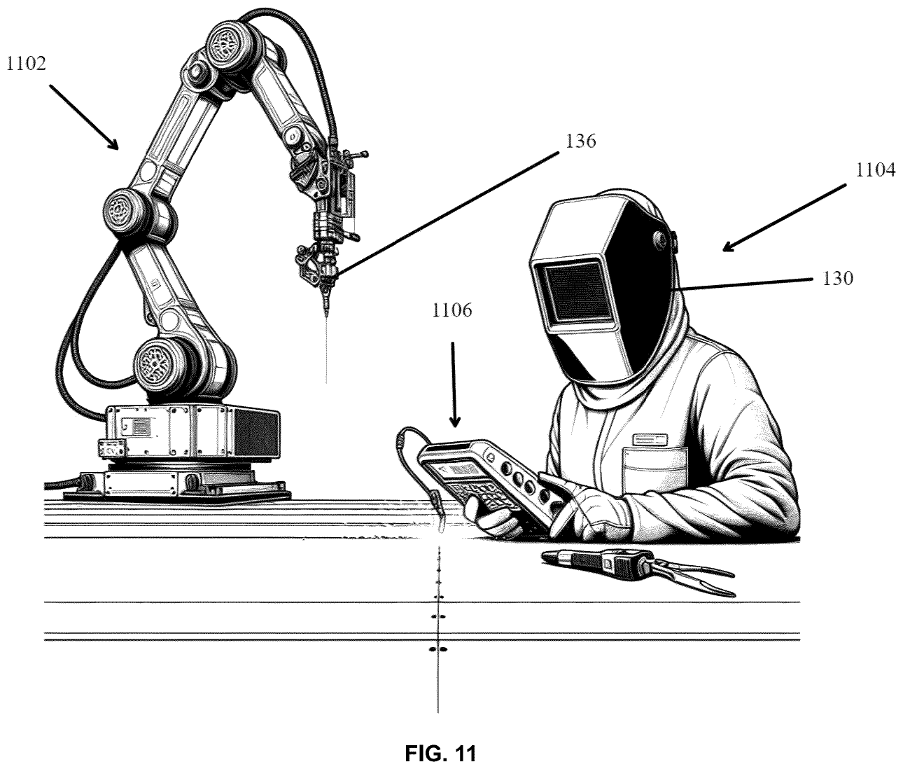

FIG. 11 illustrates a system for performing robotic work, for example a robotic welding operation according to an embodiment. The system includes a robotic unit 1102 for performing any of the work tasks described herein, including for example welding. The robotic unit 1102 may include the computer system 1000 described above. The robotic unit 1102 may also include the tool 136, such as a welding tool. The robotic unit 1102 may be controlled locally by a human user to perform a welding task. For example, a user 1104 may operate or control a remote controller 1106 to control movement of the robotic unit 1102 during the work task. The remote controller 1106 can be a joystick, glove, keypad, or other type of tool. In other embodiments, the remote controller is a handheld tool to perform a task (e.g., weld, sand, polish, chamfer, debur, paint, play a video game, etc.). Communication between the remote controller 1106 and the robotic unit 1102 can be made via one or more of the networks described herein.

They system can also include a microphone, such as the one described above. The microphone is configured to generate audio signals associated with the tool 136 performing the work task, e.g., welding. As the system includes the computer system (e.g., computer system 1000) described above, the system has a memory device, and a processing device communicatively coupled to the memory device and the microphone.

The memory device stores instructions that the processing device executes. These instructions enable the processing device to execute an artificial intelligence agent. The artificial intelligence agent is trained to perform various functions to determine specific information from the audio signals generated during the welding operation.

The artificial intelligence agent is configured to perform the following functions. First, the artificial intelligence agent can process the audio signals to identify sound signatures indicative of a weld defect occurring during the welding operation. This is achieved by analyzing the acoustic characteristics captured by the microphone, which are influenced by the welding activities performed by the robotic unit 1102 as controlled by the user through the remote controller 1106. In some embodiments, the artificial intelligence agent may further be trained to detect the presence of a burn-through or other weld defects by analyzing additional inputs such as video data and/or haptic feedback data. The video data may be obtained from cameras monitoring the welding process, capturing visual anomalies that could indicate overheating, or penetration issues often associated with burn-throughs. Similarly, haptic feedback devices may provide data related to the physical resistance experienced during the welding, which can also be indicative of underlying defects in the welding material or technique.

Once the sound signatures indicative of a weld defect is identified, the artificial intelligence agent then determines the presence of the weld defect based on these identified sound signatures. This determination is crucial for real-time monitoring and quality control of the welding process, ensuring that potential defects are identified and addressed promptly.

Upon determining the presence of the weld defect, the processing device issues cease commands. These cease commands instruct the cessation of the operation of the weld tool, effectively halting the welding process to prevent further progression of the weld defect. The cease commands can cause a display to be provided on the vocational mask 130 as described above. (See, e.g., FIG. 6). The cease commands may also cause the robotic unit 1102 to automatically stop the work, e.g., welding.

In some embodiments, the system further performs operations to process audio signals that are characteristic of specific welding activities such as burn throughs. The processing of audio signals includes executing a Fast Fourier Transform (FFT) on the audio signals. The FFT transforms the audio signals from a time domain into a frequency domain, which is essential for accurately identifying frequencies present in the audio signals that are indicative of certain welding conditions, such as burn throughs.

Further, in some embodiments, the processing of audio signals involves comparing the frequencies determined by the FFT with stored frequencies known to be associated with burn throughs. This comparison helps in accurately identifying whether the audio signals correspond to normal welding conditions or if they indicate a potential weld defect such as burn through. When the comparison confirms the presence of frequencies associated with burn throughs, this triggers a response in the system to take appropriate actions to mitigate the defect. The response may be a warning or message displayed on the vocational mask, or an automatic ceasing of the robotic welding, or both.

In some embodiments, the system incorporates a machine learning model that is specifically trained to associate sound frequencies detected during a welding operation with the occurrence of a phenomenon known as burn through. This training involves the aggregation and analysis of numerous data sets, which include audio recordings taken during various welding operations under controlled conditions. Each recording is annotated or labeled to indicate whether a burn through occurred during the welding session from which the audio was captured.

In embodiments, the training process for the machine learning model involves one or more of the following. Initially, the audio data is preprocessed to filter out irrelevant noises or frequencies that do not significantly contribute to the identification of burn through. This preprocessing may involve techniques such as noise reduction and normalization of audio levels. Subsequently, the preprocessed audio data undergoes a transformation process, where techniques such as Fast Fourier Transform (FFT) are applied to convert the audio from the time domain into the frequency domain.

Once the audio data is in the desired format, the machine learning model employs supervised learning algorithms to learn the correlation between specific frequency patterns and the presence of burn through. The training involves adjusting the parameters of the model (e.g., weights in a neural network) to minimize the error between the model's predictions and the actual labeled outcomes in the training data. This iterative process of adjustment is guided by optimization algorithms such as gradient descent.

After the training phase, the machine learning model's performance can be validated using a separate set of audio data that was not used during the training process. This validation serves to evaluate the model's accuracy and its ability to generalize to new, unseen data. If the model demonstrates adequate performance metrics (e.g., accuracy, precision, recall), it is then deployed within the system to function in real-time during actual welding operations.

During operational use, the system continuously captures audio signals from the welding environment through the microphone. These audio signals are instantly processed and transformed into the frequency domain using FFT (for example), like the preprocessing done during the training phase. The transformed audio data is then fed into the trained machine learning model, which assesses the data for frequency patterns indicative of burn through.

If the model identifies such patterns and consequently determines the likelihood of a burn through occurring, it triggers the system to take preemptive actions to mitigate potential damage or product quality issues. These actions include issuing cease commands to halt the welding operation, alerting a supervisor or a remote operator, or switching the operation to a safer welding mode, thus ensuring adherence to quality and safety standards in the welding process. Through this advanced application of machine learning technology, the system enhances the reliability and consistency of welding operations by providing a dynamic, automated response to potential quality defects.

In some embodiments, the system includes the use of a camera (described above) integrated within a welding system to enhance the detection and analysis of weld defects during welding operations. Specifically, some embodiments involve a camera configured to capture real-time images of the area being welded as the welding progresses. These images can aid in identifying various visual indicators that correspond to welding defects such as burn through.

The camera is positioned to capture detailed visual content of the weld tool and the immediate welding area. During welding, the camera records consecutive images at high resolution to ensure that even minute changes in the welding environment are captured. These images are then processed using an advanced image analysis system integrated within the welding system's processing device.

One aspect of this embodiment is the analysis of light pulse frequencies emitted from the weld tool, which are captured in the images taken by the camera. Burn throughs in welding often result in subtle yet detectable changes in light emissions, which are typically difficult to observe with the naked eye due to their brief occurrence and intricate nature. However, with the high-resolution capabilities of the camera, these pulse frequencies of light can be accurately captured in the form of image signatures.

In embodiments, the processing device of the system utilizes these captured images to conduct an analysis of the detected pulse frequencies. This involves comparing the pulse frequencies observed in the images to a pre-stored database of pulse frequency signatures known to correlate with different types of weld defects, including burn throughs. This comparison is facilitated by machine learning models that have been trained to recognize and differentiate between normal welding conditions and potential defects based on the pulse frequencies captured in the images.

When a match is identified between the observed pulse frequencies and those associated with known weld defects, the processing device interprets this as the presence of a potential weld defect. Subsequently, appropriate actions are initiated, such as adjusting the welding parameters, alerting the operator, or automatically ceasing the welding operation to prevent further damage or subpar quality of the weld.

The integration of the camera and the ability to analyze pulse frequencies of light provide a significant enhancement in the precision and reliability of weld quality assessments. By automating the detection process and reducing reliance on manual inspections, this system not only improves the efficiency of welding operations but also considerably enhances the safety and structural integrity of the welded products.

In some embodiments, the system further includes a functionality where the determination of a burn through initiates a telework session, enhancing both the operational safety and the educational aspects of the welding process. This initiates when the microphone coupled with the system identifies audio signals that match pre-defined sound signatures indicative of a potential burn through during the welding operation. Upon this determination, the system is programmed to temporarily cease the manual operation by the apprentice and transition control of the welding operation to a master welder who is located remotely.

The system facilitates this remote intervention by establishing a telework session where the master welder takes over the controls of the welding robot. This session is enabled through a network interface that supports real-time communication between the vocational masks worn by the apprentice and the master welder. The master's adjustments and techniques to mitigate or prevent the burn through are directly related to the welding robot, providing a real-time corrective approach.

During this telework session, not only is the welding operation adjusted to avoid potential defects, but it also serves as a live instructional demonstration for the apprentice. The actions and techniques applied by the master welder are streamed in real-time and can be displayed on the screen integrated into the apprentice's vocational mask. This setup allows the apprentice to observe and learn effective welding techniques and decisions in managing or preventing burn throughs, as demonstrated by the experienced welder.

Additionally, the system ensures that all movements, adjustments, and techniques performed by the master welder during the telework session are recorded. These recordings can later be accessed for further training and review, enhancing the learning curve of the apprentice through repeated viewing and analysis of the master's expert handling of potential welding defects. This embodiment not only augments the safety measures by immediately addressing welding defects but also integrates a significant educational component, transforming potential welding errors into learning opportunities without compromising on the product's structural integrity.

In some embodiments of telework sessions, control of the tool by the master, which provides real-time remediation of a detected burn-through during a welding operation, may also include the transfer of haptic feedback to the apprentice. This configuration enables the apprentice to physically sense and learn from the corrective actions executed by the master. The system includes haptic interfaces designed to precisely replicate the touch, pressure, and motion applied by the master to the tool during the remediation process. Such replication is enabled through peripheral haptic devices 134 that are communicatively coupled with the tools 136 of both the master and the apprentice. Through this bidirectional communication, each adjustment or movement made by the master in response to the detected burn-through is instantaneously mirrored and transmitted to the apprentice via the apprentice's peripheral haptic device 134. This real-time haptic feedback allows the apprentice to acquire tactile experience and a more comprehensive understanding of the adjustments necessary to address or correct the weld defect, thus improving the learning process and skill development in welding techniques.

In some embodiments, the microphone, peripheral haptic device, camera, and display are not necessarily integrated into or part of a welding mask. These components can exist as standalone units or devices, separate from a welding mask. This configuration allows for flexibility in how the system is set up and used, depending on the specific requirements of the welding operation or the preferences of the user. Each component can be individually positioned and operated, providing versatility and the potential for customization in various industrial environments.

In some embodiments, in response to a determination that a potential burn through is occurring, the system is configured to automatically adjust the welding parameters, such as reducing the welding power, amplitude, speed, etc. to mitigate the risk of a burn through. This can be performed automatically or be commanded to be performed manually by the user by issuing appropriate visual or audio instructions to the user. These proactive measures allow for real-time adjustments that enhance the quality and safety of the welding operation.

The system described herein may further include embodiments wherein a welder manually performs a welding operation on an object, instead of relying on a robotic welding unit, while still utilizing the machine learning principles for identifying weld defects previously described. In this manual welding embodiment, the system comprises sensors such as a microphone and/or a camera, a weld tool such as a handheld welder, a memory device, and a processing device, such as those described above. In these embodiments, upon identifying sound signatures that predict the onset of a weld defect (e.g., burn through), the artificial intelligence agent triggers an alert mechanism that can manifest as an auditory warning through speakers or a visual alert on a display interface provided to the welder. This rapid alert enables the welder to adjust his technique, such as by modifying the weld intensity, speed, or tool angle to mitigate the developing defect. In some embodiments, a telework session such as described above is initiated upon the determination of a weld defect. The telework session can include the haptic feedback, audio, visual display, and/or other features described herein.

Furthermore, the system may also initiate a precautionary halt of welding operations by sending a signal to disengage the weld tool temporarily. This function is particularly useful in scenarios where the detected defect (e.g., burn through) might lead to critical failures or when immediate manual correction is not feasible.

In situations where continual feedback is essential for quality control and training, the system can record the audio and corresponding actions taken by the welder for later review. This data can be used for further training of the artificial intelligence models to enhance their accuracy and for instructional purposes to aid new welders in identifying and correcting potential weld defects based on acoustic cues.

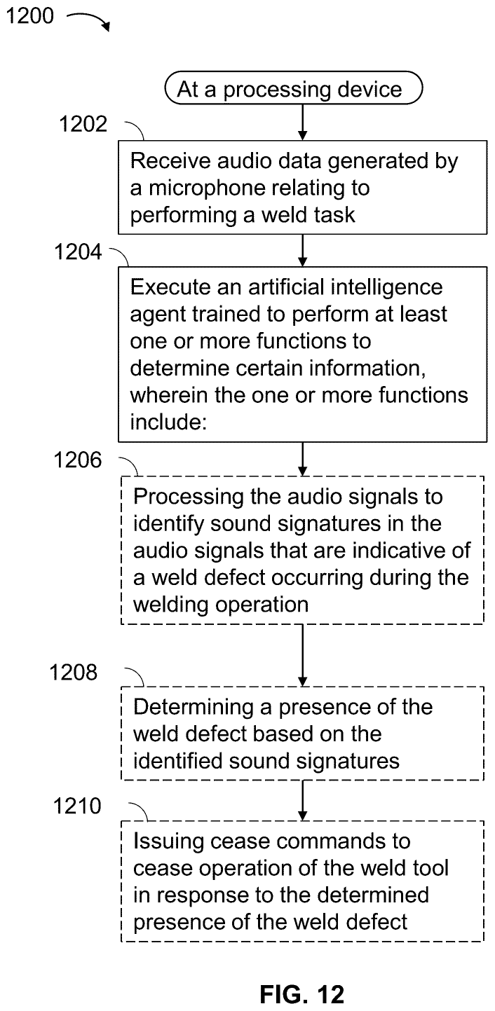

FIG. 12 illustrates an example of a method 1200 for transmitting instructions for performing a work task based on audio signal processing according to certain embodiments of this disclosure. The method 1200 may be performed by processing logic that may include hardware (circuitry, dedicated logic, etc.), software, or a combination of both. The method 1200 and/or each of their individual functions, subroutines, or operations may be performed by one or more processing devices of a computing device (e.g., any component (server 128, training engine 152, machine learning models 154, etc.) of cloud-based computing system 116, vocational mask 130, edge processor 132 (132.1, 132.2), peripheral haptic device 134, tool 136, and/or computing device 140 of FIG. 1) implementing the method 700 or 800. The method 1200 may be implemented as computer instructions stored on a memory device and executable by the one or more processors. In certain implementations, the method 1200 may be performed by a single processing thread. Alternatively, the method 1200 may be performed by two or more processing threads, each thread implementing one or more individual functions, routines, subroutines, or operations of the methods.

For simplicity of explanation, the method 1200 is depicted and described as a series of operations. However, operations in accordance with this disclosure can occur in various orders or concurrently, and with other operations not presented and described herein. For example, the operations depicted in the method 1200 may occur in combination with any other operation of any other method disclosed herein. Furthermore, not all illustrated operations may be required to implement the method 1200 in accordance with the disclosed subject matter. In addition, those skilled in the art will understand and appreciate that the method 1200 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include several nodes included in each layer of the machine learning models, an objective function executed at each node, a number of layers, various weights associated with outputs of each node, and the like.

At block 1202, the processing device may receive an audio data feed from a microphone. The microphone can be integrated with the vocational mask 130. Alternatively, the microphone can be at a fixed location at, near or adjacent a welding workstation or a robotic welding unit. The microphone, when integrated with the vocational mask 130, functions to capture audio signals, primarily the sound of a welding operation. This configuration facilitates capturing audio signals associated with welding operations especially in environments where normal speech may be obstructed by noise or physical barriers. When the microphone is positioned at a fixed location, such as near or adjacent to a welding workstation or robotic welding unit, it serves to capture ambient sounds or operational commands pertinent to the functioning, performing, and monitoring of the welding process. At this fixed location, the microphone may be attached to a stationary object or embedded within a part of the workstation or robotic unit to ensure stability and optimal audio pick-up. The placement of the microphone, whether integrated with the vocational mask or fixed near the workstation, is selected to enhance the clarity of captured audio signals while minimizing interference from background noises prevalent in industrial settings.

The audio data feed may include audio signals associated with a weld tool 136 being used by a user to perform a welding operation on an object. For example, the audio signals may be include amplitude and other features extracted from, or included in, the basic raw audio, captured over time.

At block 1204, the processing device may execute an artificial intelligence agent trained to perform at least one or more functions to determine certain information. The functions can include (i) processing the audio signals to identify sound signatures in the audio signals that are indicative of a weld defect occurring during the welding operation 1206, (ii) determining a presence of the weld defect based on the identified sound signatures 1208, and (iii) issuing cease commands to cease operation of the weld tool in response to the determined presence of the weld defect 1210.

At block 1206, the processing of the audio signals to identify sound signatures indicative of a weld defect during the welding operation involves capturing audio using the microphone positioned in proximity to the welding activities. The captured audio signals are then analyzed to detect anomalies that deviate from baseline welding audio profiles stored in the system's database. These anomalies could represent unusual noise patterns, fluctuations in sound intensity, or specific acoustic signatures associated with known welding defects such as burn through, cracks or inadequate joint penetrations. FFT may be used. Utilizing advanced digital signal processing techniques, such as spectral analysis or wavelet transforms, the system isolates these critical sound signatures from the background noise. This process serves to accurately pinpoint potential flaws in the welding process, thereby enabling timely interventions to prevent defective welds from progressing.

At block 1208, upon processing the audio signals and identifying sound signatures in the audio signals that suggest a potential weld defect such as a burn through, the system can determine, verify and assess the severity of these indications. This is achieved by comparing the extracted sound signatures with pre-existing data patterns associated with different types of welding defects, which are stored in the system's memory. The machine learning algorithms described above can evaluate the correlation between the detected sound signatures and various defect types by employing classification or regression models that have been trained on numerous datasets of welding sounds and corresponding defect labels. If the comparison confirms that the sound signatures closely match those of a specific weld defect, the system logs the presence of this defect, triggering procedural protocols to address the issue effectively.

At block 1210, one such procedural protocol involves the system issuing cease commands to the weld tool or the welding robot controlling the tool once a weld defect has been confirmed. These commands can be crucial for preventing the continuation of a flawed welding operation that could result in substandard structural integrity or safety issues in the welded product. The ceasing of welding activities is automated through electronic control systems that are integrated into the welding machinery. This immediate halt not only prevents the potential expansion of the detected defect but also facilitates a controlled environment where further analysis and corrective measures can be undertaken.

In other embodiments, the system may be configured to initiate a telework session in addition to, or instead of, sending cease commands. This teleworks session enables a remote operator to assume control over the welding operation. The initiation of a telework session facilitates real-time interaction with the welding apparatus, whereby the remote operator can execute operational commands, modify welding parameters, or intervene in the welding process as required. This feature allows for enhanced flexibility and oversight in welding operations, particularly in scenarios where direct, on-site supervision is impractical. In addition, during this interaction, the master operator's adjustments and inputs can be mirrored in the apprentice operator's interface via haptic feedback devices. This feedback mechanism allows the apprentice to experience the tactile sensations corresponding to the master's corrective actions, thereby facilitating a learning process aimed at reducing or avoiding weld defects.

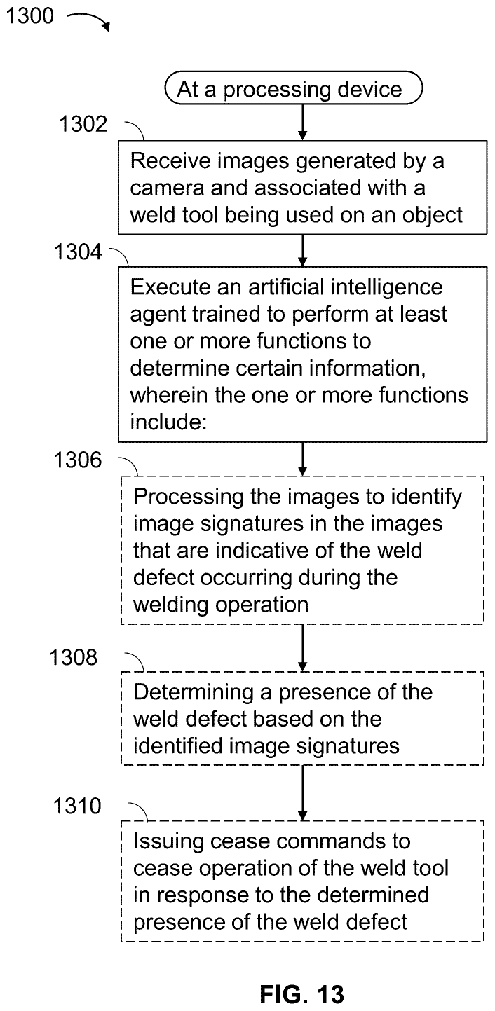

FIG. 13 illustrates an example of a method 1300 for transmitting instructions for performing a work task based on image processing according to certain embodiments of this disclosure. The method 1300 may be performed by processing logic that may include hardware (circuitry, dedicated logic, etc.), software, or a combination of both. The method 1300 and/or each of their individual functions, subroutines, or operations may be performed by one or more processing devices of a computing device (e.g., any component (server 128, training engine 152, machine learning models 154, etc.) of cloud-based computing system 116, vocational mask 130, edge processor 132 (132.1, 132.2), peripheral haptic device 134, tool 136, and/or computing device 140 of FIG. 1) implementing the method 700 or 800. The method 1300 may be implemented as computer instructions stored on a memory device and executable by the one or more processors. In certain implementations, the method 1300 may be performed by a single processing thread. Alternatively, the method 1300 may be performed by two or more processing threads, each thread implementing one or more individual functions, routines, subroutines, or operations of the methods. The method may be combined with other methods disclosed herein, such as the method 1200.

For simplicity of explanation, the method 1300 is depicted and described as a series of operations. However, operations in accordance with this disclosure can occur in various orders or concurrently, and with other operations not presented and described herein. For example, the operations depicted in the method 1300 may occur in combination with any other operation of any other method disclosed herein. Furthermore, not all illustrated operations may be required to implement the method 1300 in accordance with the disclosed subject matter. In addition, those skilled in the art will understand and appreciate that the method 1300 could alternatively be represented as a series of interrelated states via a state diagram or events.

In some embodiments, one or more machine learning models may be generated and trained by the artificial intelligence engine and/or the training engine to perform one or more of the operations of the methods described herein. For example, to perform the one or more operations, the processing device may execute the one or more machine learning models. In some embodiments, the one or more machine learning models may be iteratively retrained to select different features capable of enabling optimization of output. The features that may be modified may include several nodes included in each layer of the machine learning models, an objective function executed at each node, a number of layers, various weights associated with outputs of each node, and the like.

At block 1302, the processing device may receive one or more images or a video feed from a camera. The camera can be integrated with the vocational mask 130. Alternatively, the camera can be at a fixed location at, near or adjacent a welding workstation or a robotic welding unit. The camera, when integrated with the vocational mask, functions to capture images of the welding operation. This can include images of the pulses supplied by the welding tool.

At block 1304, the processing device may execute an artificial intelligence agent trained to perform at least one or more functions to determine certain information. The functions can include (i) processing the images to identify image signatures in the images that are indicative of the weld defect occurring during the welding operation at block 1306, (ii) determining a presence of the weld defect based on the identified image signatures at block 1308, and (iii) issuing cease commands to cease operation of the weld tool in response to the determined presence of the weld defect at block 1310.

### Clauses

1. A system comprising:
a microphone configured to generate audio signals associated with a weld tool being used by a user to perform a welding operation on an object.
a memory device storing instructions; and
a processing device communicatively coupled to the memory device and the microphone, wherein the processing device executes the instructions to:
execute an artificial intelligence agent trained to perform at least one or more functions to determine certain information, wherein the one or more functions comprise:
processing the audio signals to identify sound signatures in the audio signals that are indicative of a weld defect occurring during the welding operation,
determining a presence of the weld defect based on the identified sound signatures, and
issuing cease commands to cease operation of the weld tool in response to the determined presence of the weld defect.

2. The system of any clause herein, further comprising a welding robot that comprises the weld tool, wherein the one or more functions comprise:
issuing cease commands to cease operation of the welding robot in response to the presence of the weld defect.

3. The system of any clause herein, further comprising a network interface configured to enable bidirectional communication with a second network interface associated with a second weld tool remote from the weld tool and operated by a second user, wherein the bidirectional communication enables transmission of real-time or near real-time audio and video data, recorded audio and video data, or some combination thereof between the user and the second user.

4. The system of any clause herein, further comprising:
a peripheral haptic device communicatively coupled with the weld tool; and
a haptic interface configured to perform bidirectional haptic sensing and stimulation using the peripheral haptic device and the bidirectional communication between the user and the second user, wherein the stimulation comprises performing mimicked gestures via the peripheral haptic device.

5. The system of any clause herein, wherein the one or more functions comprise:
initiating a telework session in which the peripheral haptic device is configured to provide haptic stimulation or movement in response to haptic stimulation or movement of a second peripheral haptic device communicatively coupled with the second weld tool and connected to the peripheral haptic device via the bidirectional communication.

6. The system of any clause herein, wherein the telework session is initiated in response to the determined presence of the weld defect.

7. The system of any clause herein, wherein the weld defect is associated with a burn through, and the sound signatures in the audio signals are associated with burn throughs.

8. The system of any clause herein, wherein the processing the audio signals includes executing a Fast Fourier Transform (FFT) on the audio signals in real time to determine frequencies associated with the audio signals.

9. The system of any clause herein, wherein the processing the audio signals includes comparing the determined frequencies with stored frequencies associated with the sound signatures that are associated with the burn throughs.

10. The system of any clause herein, wherein the one or more functions comprise:
enabling a remote user to take control of the weld tool in response to the comparing of the determined frequencies with the stored frequencies indicating the presence of the weld defect.

11. The system of any clause herein, further comprising:
a camera configured to generate images associated with the weld tool being used by the user to perform the welding operation on the object.
wherein the one or more functions further comprise:
processing the images to identify image signatures in the images that are indicative of the weld defect occurring during the welding operation, and
determining the presence of the weld defect based on the identified image signatures.

12. The system of any clause herein, wherein the image signatures are associated with pulse frequencies of light emitted by the weld tool.

13. A computer-implemented method comprising:
generating audio signals associated with a weld tool being used by a user to perform a welding operation on an object; and
executing an artificial intelligence agent trained to perform at least one or more functions to determine certain information, wherein the one or more functions comprise:
processing the audio signals to identify sound signatures in the audio signals that are indicative of a weld defect occurring during the welding operation,
determining a presence of the weld defect based on the identified sound signatures, and
issuing cease commands to cease operation of the weld tool in response to the determined presence of the weld defect.

14. The method of any clause herein, further comprising:
in response to the presence of the weld defect, issuing cease commands to cease operation of a welding robot that comprises the weld tool.

15. The method of any clause herein, further comprising:
facilitating bidirectional communication with a second network interface associated with a second weld tool remote from the weld tool and operated by a second user, wherein the bidirectional communication enables transmission of real-time or near real-time audio and video data, recorded audio and video data, or some combination thereof between the user and the second user.

16. The method of any clause herein, further comprising:
coupling a peripheral haptic device with the weld tool; and
performing bidirectional haptic sensing and stimulation using the peripheral haptic device and the bidirectional communication between the user and the second user, wherein the stimulation comprises performing mimicked gestures via the peripheral haptic device.

17. The method of any clause herein, wherein the one or more functions comprise:
initiating a telework session in which the peripheral haptic device is configured to provide haptic stimulation or movement in response to haptic stimulation or movement of a second peripheral haptic device communicatively coupled with the second weld tool and connected to the peripheral haptic device via the bidirectional communication.

18. The method of any clause herein, wherein the telework session is initiated in response to the determined presence of the weld defect.

19. The method of any clause herein, wherein the weld defect is associated with a burn through, and the sound signatures in the audio signals are associated with burn throughs.

20. A non-transitory computer-readable medium storing instructions that, when executed by a processing device, cause the processing device to:
execute an artificial intelligence agent trained to perform at least one or more functions to determine certain information, wherein the one or more functions comprise:
processing audio signals generated by a microphone associated with a weld tool being used by a user to perform a welding operation on an object, to identify sound signatures in the audio signals that are indicative of a weld defect occurring during the welding operation,
determining a presence of the weld defect based on the identified sound signatures, and
issuing cease commands to cease operation of the weld tool in response to the determined presence of the weld defect.
facilitate communication with a network interface associated with a second weld tool remote from the weld tool and operated by a second user, wherein the bidirectional communication enables transmission of real-time or near real-time audio and video data, recorded audio and video data, or some combination thereof between the user and the second user.
initiate a telework session in which a peripheral haptic device is configured to provide haptic stimulation or movement in response to haptic stimulation or movement of a second peripheral haptic device communicatively coupled with the second weld tool and connected to the peripheral haptic device via the bidirectional communication

The foregoing description, for purposes of explanation, used specific nomenclature to provide a thorough understanding of the described embodiments. However, it should be apparent to one skilled in the art that the specific details are not required to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

1. A system comprising:
a microphone configured to generate audio signals associated with a weld tool being used by a user to perform a welding operation on an object.
a memory device storing instructions; and
a processing device communicatively coupled to the memory device and the microphone, wherein the processing device executes the instructions to:
execute an artificial intelligence agent trained to perform at least one or more functions to determine certain information, wherein the one or more functions comprise:
processing the audio signals to identify sound signatures in the audio signals that are indicative of a weld defect occurring during the welding operation,
determining a presence of the weld defect based on the identified sound signatures, and
issuing cease commands to cease operation of the weld tool in response to the determined presence of the weld defect.

2. The system of claim 1, further comprising a welding robot that comprises the weld tool, wherein the one or more functions comprise:
issuing cease commands to cease operation of the welding robot in response to the presence of the weld defect.

3. The system of claim 1, further comprising a network interface configured to enable bidirectional communication with a second network interface associated with a second weld tool remote from the weld tool and operated by a second user, wherein the bidirectional communication enables transmission of real-time or near real-time audio and video data, recorded audio and video data, or some combination thereof between the user and the second user.

4. The system of claim 3, further comprising:
a peripheral haptic device communicatively coupled with the weld tool; and
a haptic interface configured to perform bidirectional haptic sensing and stimulation using the peripheral haptic device and the bidirectional communication between the user and the second user, wherein the stimulation comprises performing mimicked gestures via the peripheral haptic device.

5. The system of claim 4, wherein the one or more functions comprise:
initiating a telework session in which the peripheral haptic device is configured to provide haptic stimulation or movement in response to haptic stimulation or movement of a second peripheral haptic device communicatively coupled with the second weld tool and connected to the peripheral haptic device via the bidirectional communication.

6. The system of claim 5, wherein the telework session is initiated in response to the determined presence of the weld defect.

7. The system of claim 1, wherein the weld defect is associated with a burn through, and the sound signatures in the audio signals are associated with burn throughs.

8. The system of claim 7, wherein the processing the audio signals includes executing a Fast Fourier Transform (FFT) on the audio signals in real time to determine frequencies associated with the audio signals.

9. The system of claim 7, wherein the processing the audio signals includes comparing the determined frequencies with stored frequencies associated with the sound signatures that are associated with the burn throughs.

10. The system of claim 9, wherein the one or more functions comprise:
enabling a remote user to take control of the weld tool in response to the comparing of the determined frequencies with the stored frequencies indicating the presence of the weld defect.

11. The system of claim 1, further comprising:
a camera configured to generate images associated with the weld tool being used by the user to perform the welding operation on the object.
wherein the one or more functions further comprise:
processing the images to identify image signatures in the images that are indicative of the weld defect occurring during the welding operation, and
determining the presence of the weld defect based on the identified image signatures.

12. The system of claim 11, wherein the image signatures are associated with pulse frequencies of light emitted by the weld tool.

13. A computer-implemented method comprising:
generating audio signals associated with a weld tool being used by a user to perform a welding operation on an object; and
executing an artificial intelligence agent trained to perform at least one or more functions to determine certain information, wherein the one or more functions comprise:
processing the audio signals to identify sound signatures in the audio signals that are indicative of a weld defect occurring during the welding operation,
determining a presence of the weld defect based on the identified sound signatures, and
issuing cease commands to cease operation of the weld tool in response to the determined presence of the weld defect.

14. The method of claim 13, further comprising:
in response to the presence of the weld defect, issuing cease commands to cease operation of a welding robot that comprises the weld tool.

15. The method of claim 13, further comprising:
facilitating bidirectional communication with a second network interface associated with a second weld tool remote from the weld tool and operated by a second user, wherein the bidirectional communication enables transmission of real-time or near real-time audio and video data, recorded audio and video data, or some combination thereof between the user and the second user.

16. The method of claim 15, further comprising:
coupling a peripheral haptic device with the weld tool; and
performing bidirectional haptic sensing and stimulation using the peripheral haptic device and the bidirectional communication between the user and the second user, wherein the stimulation comprises performing mimicked gestures via the peripheral haptic device.

17. The method of claim 16, wherein the one or more functions comprise:
initiating a telework session in which the peripheral haptic device is configured to provide haptic stimulation or movement in response to haptic stimulation or movement of a second peripheral haptic device communicatively coupled with the second weld tool and connected to the peripheral haptic device via the bidirectional communication.

18. The method of claim 17, wherein the telework session is initiated in response to the determined presence of the weld defect.

19. The method of claim 13, wherein the weld defect is associated with a burn through, and the sound signatures in the audio signals are associated with burn throughs.

20. A non-transitory computer-readable medium storing instructions that, when executed by a processing device, cause the processing device to:
execute an artificial intelligence agent trained to perform at least one or more functions to determine certain information, wherein the one or more functions comprise:
processing audio signals generated by a microphone associated with a weld tool being used by a user to perform a welding operation on an object, to identify sound signatures in the audio signals that are indicative of a weld defect occurring during the welding operation,
determining a presence of the weld defect based on the identified sound signatures, and
issuing cease commands to cease operation of the weld tool in response to the determined presence of the weld defect.
facilitate communication with a network interface associated with a second weld tool remote from the weld tool and operated by a second user, wherein the bidirectional communication enables transmission of real-time or near real-time audio and video data, recorded audio and video data, or some combination thereof between the user and the second user.
initiate a telework session in which a peripheral haptic device is configured to provide haptic stimulation or movement in response to haptic stimulation or movement of a second peripheral haptic device communicatively coupled with the second weld tool and connected to the peripheral haptic device via the bidirectional communication.
